(19) United States
(12) Patent Application Publication
(10) Pub. No.: US 2026/0113440 A1
(43) Pub. Date: Apr. 23, 2026

(54) METHOD FOR SELECTING INTRA FILTER FOR VIDEO CODING

(71) Applicant: Alibaba (China) Co., Ltd., Hangzhou (CN)

(72) Inventors: Zixiang ZHANG, Beijing (CN); Jie CHEN, Beijing (CN); Xinwei LI, Beijing (CN); Ru-ling LIAO, Sunnyvale, CA (US); Yan YE, San Diego, CA (US)

(21) Appl. No.: 19/330,528

(22) Filed: Sep. 16, 2025

Related U.S. Application Data
(60) Provisional application No. 63/708,749, filed on Oct. 17, 2024.

(51) Int. Cl. H04N 19/117; H04N 19/11; H04N 19/82

(52) U.S. Cl. CPC H04N 19/117; H04N 19/11; H04N 19/82

(57) ABSTRACT

The present disclosure provides a method of encoding a video sequence. The method includes receiving a video sequence; encoding the video sequence by deriving one or more intra modes for intra prediction; performing template matching (TM) tests on a template region using different filters for the one or more intra modes; and selecting one or more intra filters based on a TM cost.

### CROSS-REFERENCE TO RELATED APPLICATIONS

This disclosure claims the benefits of priority to U.S. Provisional Application No. 63/708,749, filed on Oct. 17, 2024, which is incorporated herein by reference in its entirety.

### TECHNICAL FIELD

The present disclosure generally relates to video processing, and more particularly, to methods for selecting intra filter for video coding.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transformation, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a method for encoding a video sequence. In some embodiments, the method includes: receiving a video sequence; encoding the video sequence by deriving one or more intra modes for intra prediction; performing template matching (TM) tests on a template region using different filters for the one or more intra modes; and selecting one or more intra filters based on a TM cost.

Embodiments of the present disclosure provide a method for decoding a bitstream. In some embodiments, the method includes receiving a bitstream; and decoding the bitstream to generate a video sequence. The decoding includes deriving one or more intra modes for intra prediction; performing template matching (TM) tests on a template region using different filters for the one or more intra modes; and selecting one or more intra filters based on a TM cost.

Embodiments of the present disclosure provide a method for signaling a bitstream. In some embodiments, the method includes: receiving a video sequence; encoding the video sequence by deriving one or more intra modes for intra prediction; performing template matching (TM) tests on a template region using different filters for the one or more intra modes; and selecting one or more intra filters based on a TM cost; and signaling a bitstream that is generated based on the encoding.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an exemplary video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, according to some embodiments of the present disclosure.

FIG. 5 is a schematic diagram illustrating exemplary reference samples used in planar mode, according to some embodiments of the present disclosure.

FIG. 6 is a schematic diagram illustrating 67 exemplary intra prediction modes, according to some embodiments of the present disclosure.

FIG. 7 is a schematic diagram illustrating adjacent blocks (L, A, BL, AR, AL) used in the derivation of a general most probable mode (MPM) list, according to some embodiments of the present disclosure.

FIG. 8 is a schematic diagram illustrating an exemplary L shaped neighborhood for a given predicted block, according to some embodiments of the present disclosure.

FIG. 9 is a schematic diagram illustrating exemplary non-adjacent spatial neighboring candidates for occurrence-based intra coding (OBIC) mode, according to some embodiments of the present disclosure.

FIG. 10 is a schematic diagram illustrating an exemplary L shaped neighborhood for a given predicted block, according to some embodiments of the present disclosure.

FIG. 11 is a schematic diagram illustrating exemplary spatial geometric partition mode (SGPM) candidates, according to some embodiments of the present disclosure.

FIG. 12 is a schematic diagram illustrating exemplary GPM templates, according to some embodiments of the present disclosure.

FIG. 13 is a schematic diagram illustrating an exemplary GPM blending process, according to some embodiments of the present disclosure.

FIG. 14 is a flowchart of an exemplary method for intra filter selection, according to some embodiments of the present disclosure.

FIG. 15 is a flowchart of an exemplary method for TM-based intra filter selection, according to some embodiments of the present disclosure.

FIGS. 16A-16C illustrates different shapes of template regions, according to some embodiments.

FIGS. 17A-17D are flowcharts of different exemplary processes of template matching (TM)-based intra filter selection for spatial geometric partition mode (SGPM) candidates list construction, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are most concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., unit-prediction). A picture is referred to as a “B-picture” if at least one block in it is predicted with two reference pictures (e.g., bi-prediction).

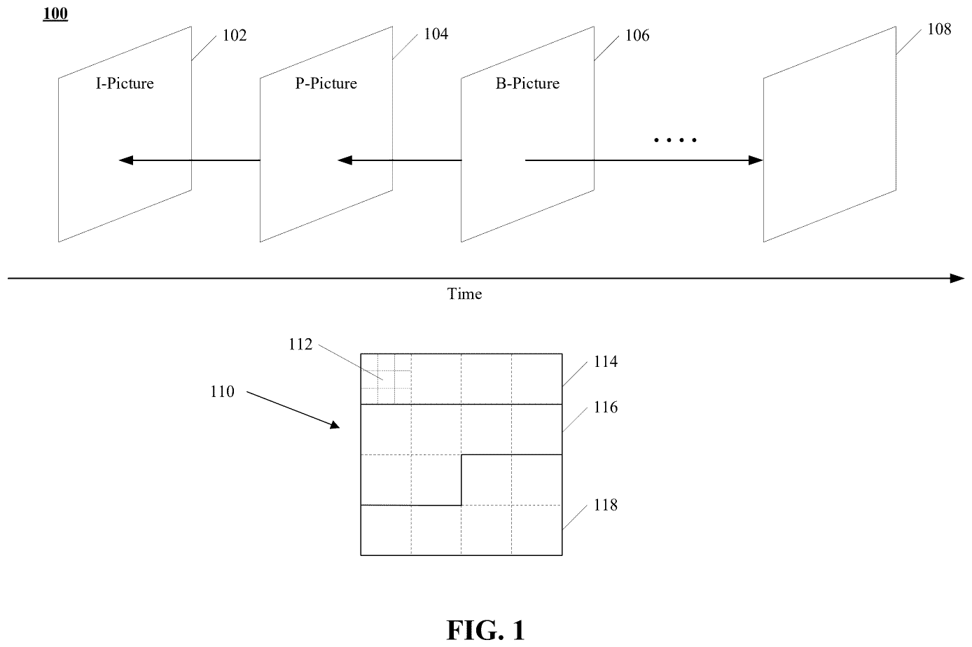

FIG. 1 illustrates structures of an exemplary video sequence 100, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) cannot be immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

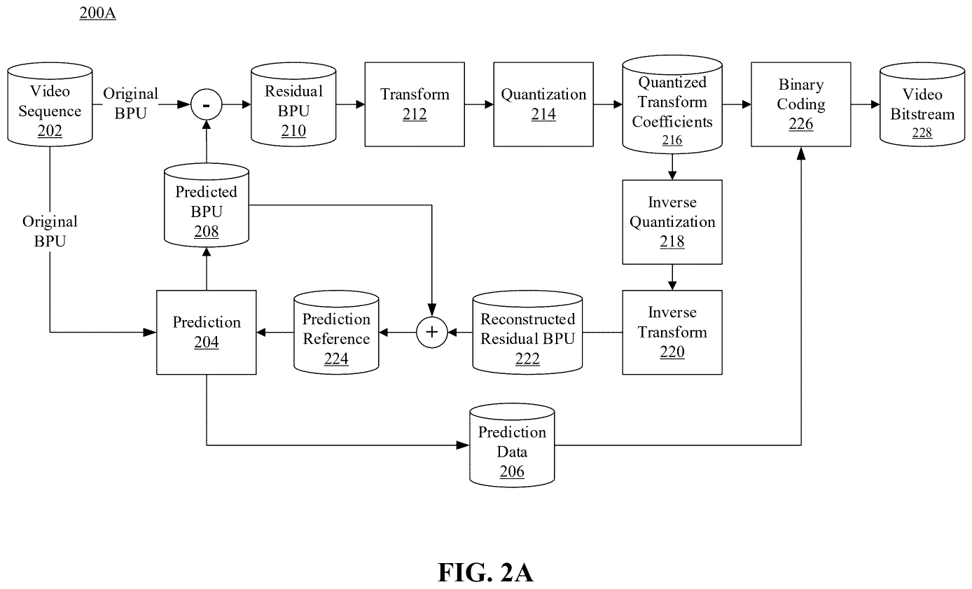

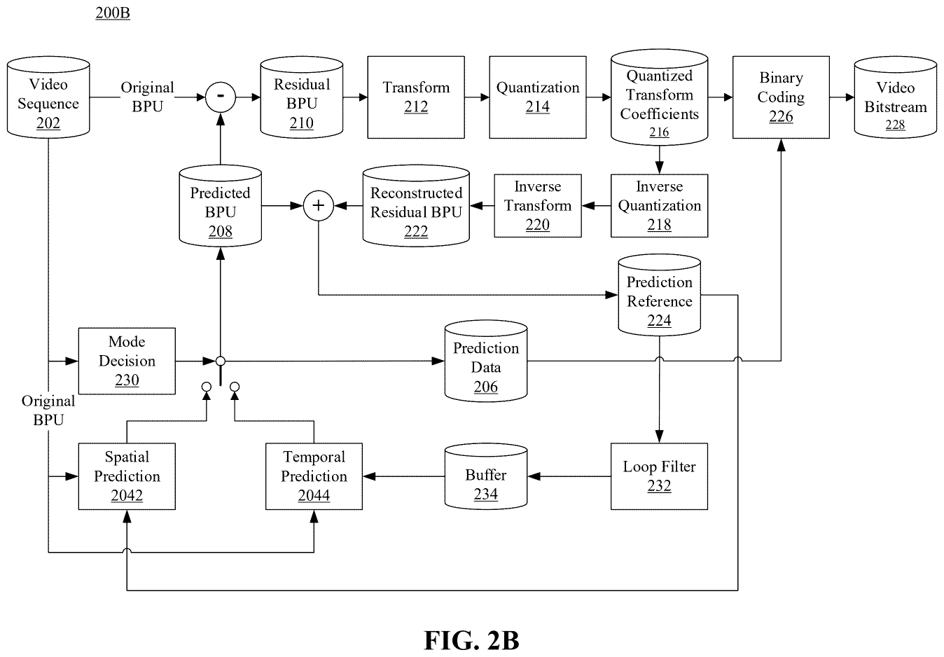

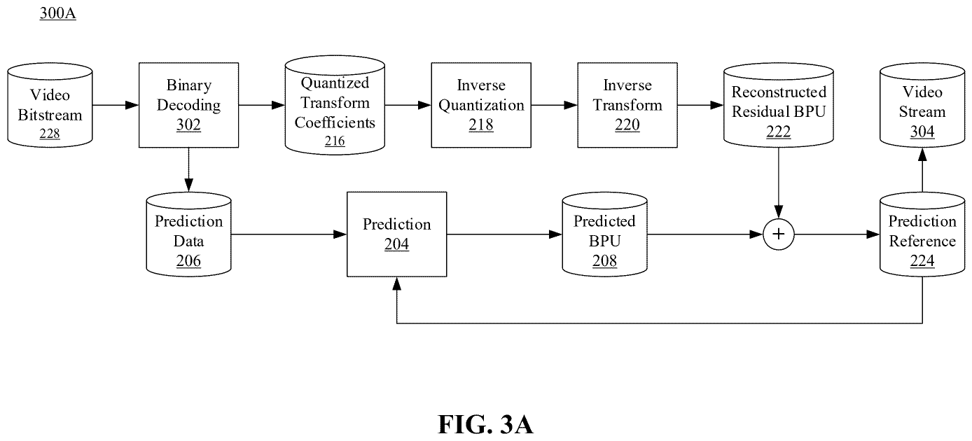

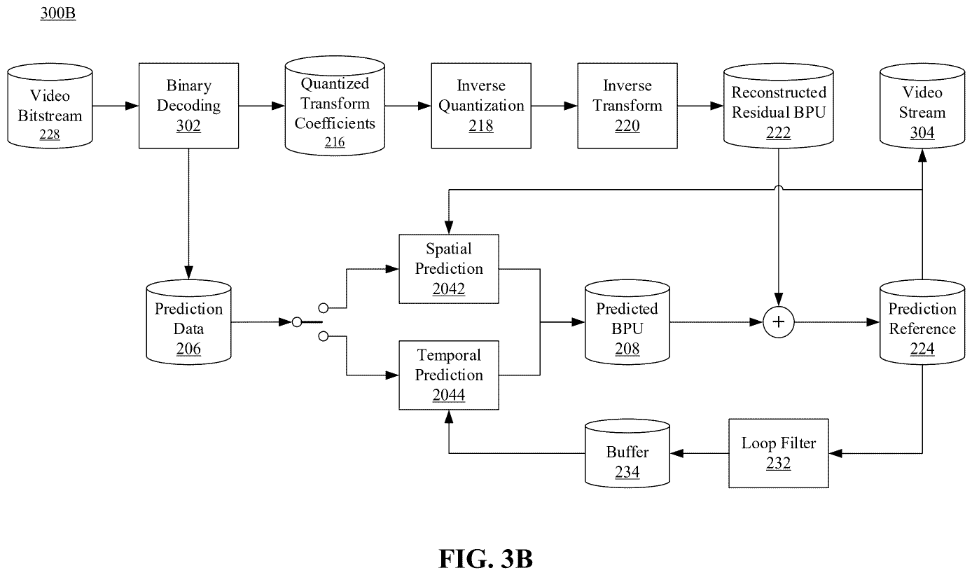

Video coding has multiple stages of operations, examples of which are shown in FIGS. 2A-2B and FIGS. 3A-3B. For each stage, the size of the basic processing units can still be too large for processing and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC) and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIG. 2A and FIG. 2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an exemplary encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224 and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization syntax element or any other syntax element of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, syntax elements of the prediction operation, a transform type at transform stage 212, syntax elements of the quantization process (e.g., quantization syntax elements), an encoder control syntax element (e.g., a bitrate control syntax element), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another exemplary encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, syntax elements of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer (DPB)”) for later use (e.g., to be used as an inter-prediction reference picture for a future picture of video sequence 202). The encoder can store one or more reference pictures in buffer 234 to be used at temporal prediction stage 2044. In some embodiments, the encoder can encode syntax elements of the loop filter (e.g., a loop filter strength) at binary coding stage 226, along with quantized transform coefficients 216, prediction data 206, and other information.

FIG. 3A illustrates a schematic diagram of an exemplary decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIG. 2A and FIG. 2B), generally, video stream 304 is not identical to video sequence 202. Similar to processes 200A and 200B in FIG. 2A and FIG. 2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, syntax elements of the prediction operation, a transform type, syntax elements of the quantization process (e.g., quantization syntax elements), an encoder control syntax element (e.g., a bitrate control syntax element), or the like. In some embodiments, if video bitstream 228 is transmitted over a network in packets, the decoder can depacketize video bitstream 228 before feeding it to binary decoding stage 302.

FIG. 3B illustrates a schematic diagram of another exemplary decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044 and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, syntax elements of the intra prediction operation, or the like. The syntax elements of the intra prediction operation can include, for example, locations (e.g., coordinates) of one or more neighboring BPUs used as a reference, sizes of the neighboring BPUs, syntax elements of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, syntax elements of the inter prediction operation, or the like. The syntax elements of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer (DPB) in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include syntax elements of the loop filter (e.g., a loop filter strength). In some embodiments, prediction data includes syntax elements of the loop filter when the prediction mode indicator of prediction data 206 indicates that inter prediction was used to encode the current BPU.

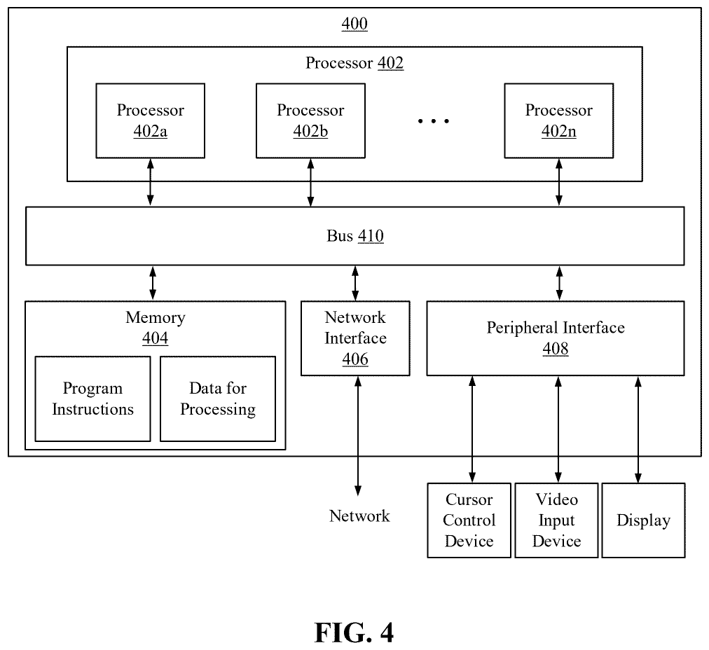

FIG. 4 is a block diagram of an exemplary apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410) and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

After VVC, the JVET starts to explore coding techniques beyond VVC using an Enhanced Compression Model (ECM). The ECM is used as a new software base for developing tools beyond the VVC standard.

First, intra prediction used in video coding is described. According to the VVC standard, the luma component can be predicted by multiple intra prediction modes. These include but are not limited to: planar mode, DC mode, angular mode, Multiple Reference Line (MRL) prediction mode, Intra Sub-partition (ISP) mode, Matrix-based Intra Prediction (MIP) mode, and Intra Block Copy (IBC) mode.

In ECM, several video compression technologies beyond VVC are being explored. In ECM, some intra prediction modes are extended. Some new intra prediction modes are added, such as Decoder-side Intra Mode Derivation (DIMD) mode, Template-based Intra Mode Derivation mode (TIMD), Template-based multiple reference line intra prediction (TMRL), intra Template Matching (intra TMP) mode and Spatial Geometric Partition mode (SGPM), etc.

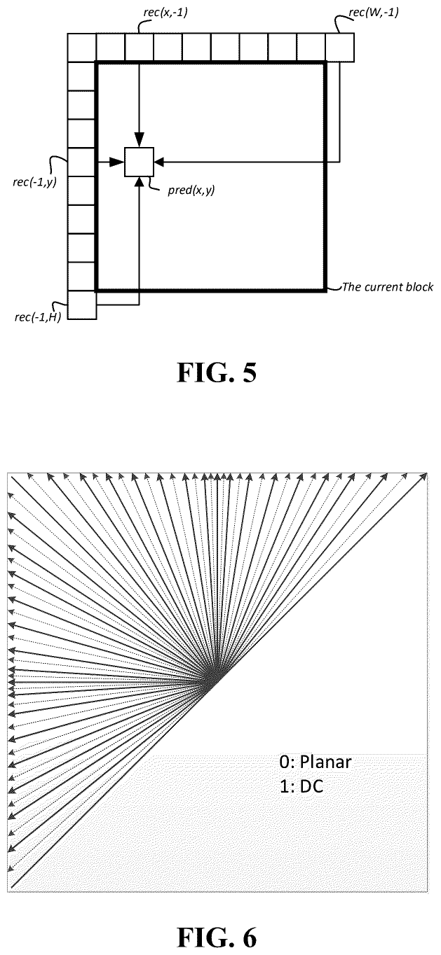

Details of the above intra prediction modes are described. In the planar mode, the predicted value of a current sample is obtained from the reconstructed values of 4 reference samples: the left reference sample in the same row as the current sample, the above reference sample in the same column as the current sample, the reference sample on the bottom-left position adjacent to the current block, and the reference sample on the top-right position adjacent to the current block. FIG. 5 is a schematic diagram illustrating exemplary reference samples used in planar mode, according to some embodiments of the present disclosure. Referring to FIG. 5, using pred(x,y) to represent the predicted value of the current sample, using H to represent the height of the current block, and using W to represent the width of the current block, then the reconstructed values of the four reference samples used in planar mode can be respectively represented as rec(−1,y), rec(x,−1), rec(−1,H) and rec(W,−1), where (x,y) represents the coordinate positions of the current sample relative to the top-left position within the current block.

The planar mode generates the predicted value of the current sample according to the Equations (1) to (3). In Equation 1, an intermediate value predV(x,y) is obtained from rec(x,−1) and rec(−1,H). In Equation 2, another intermediate value predH(x,y) is obtained from rec(−1,y) and rec(W,−1). Finally, the two intermediate values are used to generate the predicted value of the current sample according to Equation 3.

$$predV ( x , y ) = ( ( H - 1 - y ) * rec ( x , - 1 ) + ( y + 1 ) * rec ( - 1 , H ) ) << {log}_{2} W \qquad ( 1 )$$

$$predH ( x , y ) = ( ( W - 1 - x ) * rec ( - 1 , y ) + ( x + 1 ) * rec ( W , - 1 ) ) << {log}_{2} H \qquad ( 2 )$$

$$pred ( x , y ) = ( pred V ( x , y ) + pred H ( x , y ) + W * H ) >> ( {log}_{2} W + {log}_{2} H + 1 ) \qquad ( 3 )$$

An index can be used to indicate the intra prediction modes, and the planar mode can be represented as index 0.

In ECM, two additional planar modes where only the horizontal interpolation or only the vertical interpolation are used to obtain the predicted samples for luma.

For planar horizontal mode, only the horizontal linear interpolation is performed based on the left reference sample and the top-right reference sample to predict the current sample as:

$$pred ( x , y ) = ( ( W - 1 - x ) * rec ( - 1 , y ) + ( x + 1 ) * rec ( W , - 1 ) + ( W >> 1 ) ) >> {log}_{2} ( \text{} W ) \qquad ( 4 )$$

For planar vertical mode, only the vertical linear interpolation is performed based on the above reference sample and the bottom-left reference sample to predict the current sample as:

$$pred ( x , y ) = ( ( H - 1 - y ) * rec ( x , - 1 ) + ( y + 1 ) * rec ( - 1 , H ) + ( H >> 1 ) ) >> {log}_{2} ( H ) \qquad ( 5 )$$

In the DC mode, an average value of the left and above reference samples to the current block is used for prediction generation. In HEVC, every intra-coded block has a square shape and the length of each of its side (i.e. left and above) is a power of 2. Thus, no division operations are required to calculate the average value. In VVC, blocks can have a rectangular shape that necessitates the use of a division operation per block in the general case. To avoid division operations for DC prediction, only the longer side is used to compute the average value for non-square blocks. And for square blocks reference samples from both left and above sides are used to compute the average value. The DC mode can be represented as index 1.

Angular intra prediction is a directional intra prediction method, which is extended from a prior implementation according to the HEVC standard. To capture the arbitrary edge directions presented in natural video, the VVC standard extends the number of angular intra prediction modes from 33 (as used in HEVC) to 65. FIG. 6 is a schematic diagram illustrating 67 exemplary intra prediction modes, according to some embodiments of the present disclosure. As shown in FIG. 6, the modes added in VVC are illustrated in broken lines. The 65 angle modes can be represented as index 2 to index 66 from bottom left to top right.

According to the VVC standard, to keep the complexity of the most probable mode (MPM) list generation low, an intra mode coding method with 6 MPMs is used by considering two available neighboring intra modes.

A unified 6-MPM list is used for intra blocks. The MPM list is constructed based on intra modes of the left and above adjacent block. Suppose the mode of the left is denoted as Left and the mode of the above block is denoted as Above, the unified MPM list is constructed as follows:
When an adjacent block is not available, its intra mode is set to Planar by default.
If both modes Left and Above are non-angular modes:

$$- MPM list \to \{ Planar , DC , V , HG , V - 4 V + 4 \} .$$

If one of modes Left and Above is angular mode, and the other is non-angular:
   Set a mode Max as the larger mode in Left and Above;

$$MPM l ist \to \{ Planar , Max , Max - 1 , Max + 1 , Max - 2 , Max + 2 \}$$

If Left and Above are both angular and they are different:
   Set a mode Max as the larger mode in Left and Above
   Set a mode Min as the smaller mode in Left and Above
   If Max-Min is equal to 1:

$$MPM l ist \to \{ Planar , Left , Above , Min - 1 , Max + 1 , Min - 2 \}$$

Otherwise, if Max-Min is greater than or equal to 62:

$$MPM l ist \to \{ Planar , Left , Above , Min - 1 , Max + 1 , Max + 2 \}$$

Otherwise, if Max-Min is equal to 2:

$$MPM l ist \to \{ Planar , Left , Above , Min + 1 , Min - 1 , Max + 1 \}$$

Otherwise:

$$MPM l ist \to \{ Planar , Left , Above , Min - 1 , - Min + 1 , Max - 1 \}$$

If Left and Above are both angular and they are the same:

$$MPM l ist \to \{ Planar , Left , Left - 1 , Left + 1 , Left - 2 , Left + 2 , \}$$

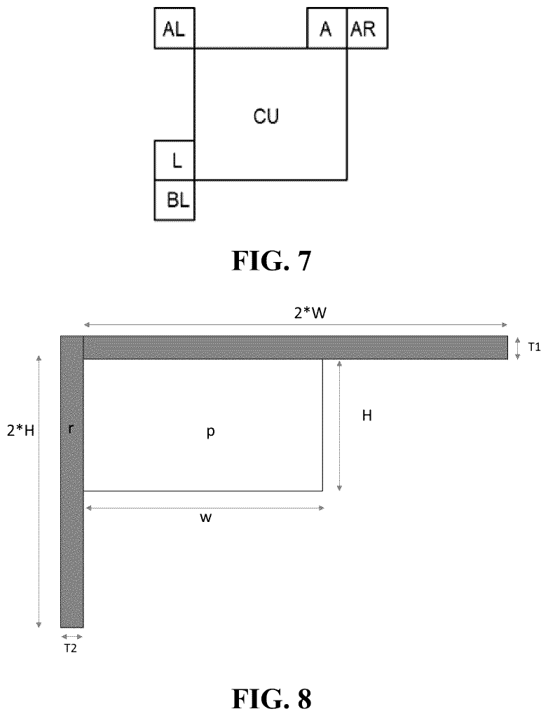

According to the ECM proposal, secondary MPM lists are introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. FIG. 7 is a schematic diagram illustrating adjacent blocks (L, A, BL, AR, AL) used in the derivation of a general most probable mode (MPM) list, according to some embodiments of the present disclosure. As shown in FIG. 7, the first entry in the general MPM list is the Planar mode. The remaining entries are composed of the intra modes of the left (L), above (A), below-left (BL), above-right (AR), and above-left (AL) adjacent blocks, and DIMD modes which are sorted in ascending order of sum of absolute difference (SAD) cost. Up to 5 modes with the smallest SAD cost are added. The SAD cost is computed between the prediction and the reconstruction samples of the template. The sorted directional modes with added offset are added into the general MPM list, and then the default modes, until the general MPM list with 22 entries is constructed.

If a block is vertically oriented, the order of neighboring blocks is A, L, BL, AR, AL; otherwise, it is L, A, BL, AR, AL.

According to the ECM proposal, the intra modes of the non-adjacent blocks can also be added to the MPM list. And the first MPM list except the planar mode is sorted by applying the intra prediction mode of each entry to a template of the current block and calculating the SAD values between predicted samples and reconstructed samples of the template.

According to the ECM proposal, some of the conventional intra prediction modes (planar, DC and the 65 angular modes) may be replaced by matrix based intra prediction modes (also called PDP mode). In the matrix based intra prediction mode, a matrix of weights, which are defined for a block shape and intra mode index, is introduced. Those weights are multiplied by the neighbor reference template to derive the predicted values of the current block. FIG. 8 is a schematic diagram illustrating an exemplary L shaped neighborhood for a given predicted block, according to some embodiments of the present disclosure. As shown in FIG. 8, the weights are applied to the reference samples of the L shaped causal neighborhood template.

The reference samples in the causal neighborhood are denoted as r, and F (x,y) is the matrix of weights. Then the predicted value pred(x,y) can be derived as:

$$pred ( x , y ) = {\sum }_{k} F ( x , y , k ) * r ( k ) \qquad ( 6 )$$

where k denotes the index of the reference sample in the template.

The prediction is used for block size with both width and height up to 32 (except for 4×32, 32×4, 8×32, and 32×8). The template size is 2 for blocks with both width and height up to 16 and the modes with index 0, 1, and (2+2×k) are replaced. For other blocks, template size is set to 1 and the modes with index 0, 1, and (2+4×k) are replaced. The prediction is only performed for 16×16 positions, and the rest of the samples are generated by bilinear interpolation. For all block sizes, block shape and mode-based symmetry is used. Reference length is set to W and H for modes with index greater than 18 and less than 50 and set to 2×W and 2×H for other modes.

Intra block copy (IBC) is well known for significantly improving the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well.

In ECM, a decoder side intra mode derivation (DIMD) mode is applied. When DIMD is applied, up to five intra modes are derived from the reconstructed neighbor samples, and those five predictors are combined with the non-directional predictor (planar or block vector-based predictor) with the weights derived from the histogram of gradients. The decision between for the non-directional modes is taken according to the template cost. Specifically, the block vectors of all adjacent and non-adjacent merge candidates (coded in IntraTMP or IBC) are compared to planar prediction on the reconstructed template. The template cost (SATD) is used to select the best predictor among them.

For a block of size W×H, the weight for each of the five derived modes is modified if the one the above or left histogram magnitudes is twice larger than the other one. In this case, the weights are location dependent and computed as follows:

If the above histogram is twice the left, then:

$${w}_{i} ( x , y ) = {wDimd}_{i} + {Δ}_{i} - 2 {Δ}_{i} \frac{y}{( H - 1 )} \qquad ( 7 )$$

And if the left histogram is twice the above, then:

$${w}_{i} ( x , y ) = {wDimd}_{i} + {Δ}_{i} - 2 {Δ}_{i} \frac{x}{( W - 1 )} \qquad ( 8 )$$

where, in Equation 7 and Equation 8, wDimdᵢ is the unmodified uniform weight of the DIMD, Δᵢ is pre-defined and set to 10.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

Finally, the region of neighboring reconstructed samples used for computing the histogram of gradients is modified, depending on reconstructed samples availability. The region of decoded reference samples of current W×H luma CB is extended towards the above-right side if available, up to W additional columns. It is extended towards the bottom-left side if available, up to H additional rows.

The occurrence-based intra coding (OBIC) as a sub-mode of DIMD, derives the intra prediction modes of the current block based on the sample-wise occurrence of the intra modes in the spatial neighborhood of the block. For this, adjacent and non-adjacent spatial neighboring blocks are checked and the intra prediction modes of the blocks are collected into an occurrence histogram. Instead of Histogram of Gradients (HoGs) as in DIMD, the OBIC method uses the Histogram of Occurrences, which consists of the intra modes and their sample-wise occurrences. The occurrence values are calculated based on the number of samples that are coded in a certain intra prediction mode in that neighborhood. For example, if a uiWidth×uiHeight block is coded with an Intra Prediction Mode (IPM), the occurrence of the mode in that block is calculated as:

$$Histogram [ IPM ] += uiWidth \times uiHeight , \qquad ( 9 )$$

where uiWidth and uiHeight are the width and height of a spatial neighboring block. The occurrences of the existing modes from the spatial neighborhood blocks are accumulated into the histogram.

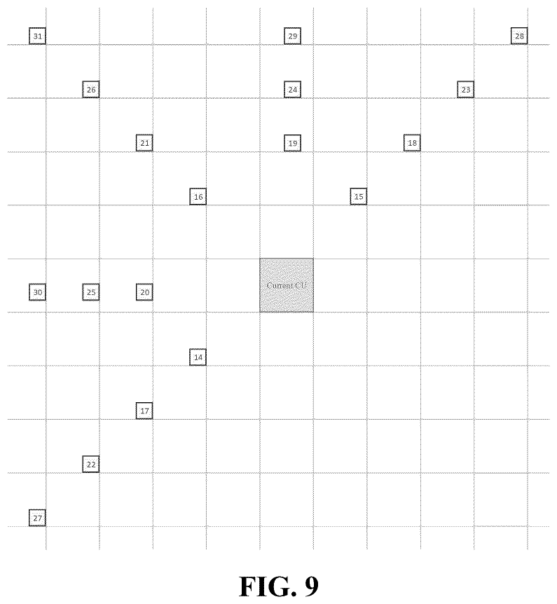

FIG. 9 is a schematic diagram illustrating exemplary non-adjacent spatial neighboring candidates for occurrence-based intra coding (OBIC) mode, according to some embodiments of the present disclosure. Specifically, FIG. 9 shows the non-adjacent spatial neighboring blocks that are used in OBIC mode's histogram generation.

Up to five angular modes with the highest occurrence along with the planar mode or block vector-based prediction (same as in DIMD) are selected from the histogram and used for final prediction by blending the prediction of the selected modes.

Some blocks mentioned below use more than one intra mode for prediction. In such cases, all the intra modes of such blocks are selected and used when creating the OBIC histogram:
DIMD: up to 5 angular modes
TIMD: up to 2 modes
SGPM: 2 modes
OBIC: up to 5 angular modes

Moreover, the virtual intra prediction modes (VIPMs) of following blocks are considered only in inter slices when creating the histogram of OBIC mode:
MIP block
IntraTMP block
EIP block

The blending weights are calculated similar to the DIMD mode, but instead of using gradient values from the template, the occurrence values are used for OBIC. Moreover, the planar mode's weight is also decided similar to DIMD mode.

The OBIC mode is used as a sub-mode of DIMD tool and is applied to only luma blocks. Moreover, the mode is disabled for blocks that have less than 64 samples.

In ECM, a template-based intra mode derivation (TIMD) mode is applied. For each intra prediction mode in MPMs, as well as the wide-angle modes if the above-right and/or bottom-left reference samples are available, Sum of Absolute Transformed Difference (SATD) between the prediction and reconstruction samples of the template is calculated. The first two intra prediction modes with the minimum SATD and one non-angular intra prediction mode (i.e. DC or Planar) with the lowest SATD cost are selected as the TIMD modes. These three TIMD modes are fused with the weights after applying position dependent intra prediction combination (PDPC) process, and such weighted intra prediction is used to code the current CU. PDPC is included in the derivation of the TIMD modes.

The conditions below are checked to determine whether the non-angular intra prediction mode is used in fusion:
the non-angular intra prediction mode is different from the two selected intra prediction modes.
costMode3<1.5×costMode1, where the costMode3 is the SATD cost of the non-angular intra prediction mode and costMode1 is the SATD cost of the first intra prediction mode.

If both of the conditions are true, three intra prediction modes are used to generate the prediction. And the weights of each intra prediction mode are computed from SATD cost:

$$weigh {t}_{i} = \frac{sumSATD - {costMode}_{i}}{2 \times sumSATD} \qquad ( 10 )$$

$$sum SATD = {\sum }_{j = 1}^{3} {costMode}_{i} \qquad ( 11 )$$

Otherwise, the non-angular intra prediction mode is not used in prediction. And the costs of the two selected modes are compared with a threshold, in the test the cost factor of 2 is applied as follows:

$$costMode 2 < 2 \times costMode 1 \qquad ( 12 )$$

If this condition is true, the fusion is applied, otherwise the only model is used.

Weights of the modes are computed from their SATD costs as follows:

$$weight1 = \frac{costMode 2}{costMode 1 + costMode 2} \qquad ( 13 )$$

$$weight2 = 1 - weigh1 \qquad ( 14 )$$

The division operations are conducted using the same lookup table (LUT) based integerization scheme used by the CCLM.

Moreover, location-dependent sample-based fusion used in DIMD fusion process is used for the TIMD fusion but the location-dependent criterion applying to amplitudes of the selected predictors is replaced by a SATD cost-based criteria. The location-dependent criterion is determined from a ratio of the normalized SATD of the selected TIMD predictors computed in above and left template area.

In ECM, a template-based multiple reference line intra prediction (TMRL) mode is applied. The TMRL mode combines reference line and prediction mode together and uses a template matching method to construct a list of candidate combinations. An index to the candidate combination list is coded to indicate which reference line and prediction mode is used in coding the current block. The regular multiple reference line (MRL) for the non-TIMD part is replaced by TMRL mode.

The TMRL mode extends reference line candidate list and the intra-prediction-mode candidate list. The extended reference line candidate list is {1, 3, 5, 7, 12}. The size of the intra-prediction-mode candidate list is 10. The construction of the intra-prediction-mode candidate list is similar to MPM except the PLANAR mode is excluded from the intra-prediction-mode candidate list, DC mode is added after 5 neighboring picture units' (PUs) modes and DIMD mode if the DIMD mode is not included and the angular modes with delta angles from +1 to +4 (compared the existing angular modes in the intra-prediction-mode candidate list) are added. The precision of angular prediction is extended from 65 to 129. Additionally non-adjacent positions are added as candidates in constructing the intra candidate list. If the neighboring or non-adjacent blocks are coded with SGPM or GPM modes, the intra modes of the blocks are replaced by the partitioning angles.

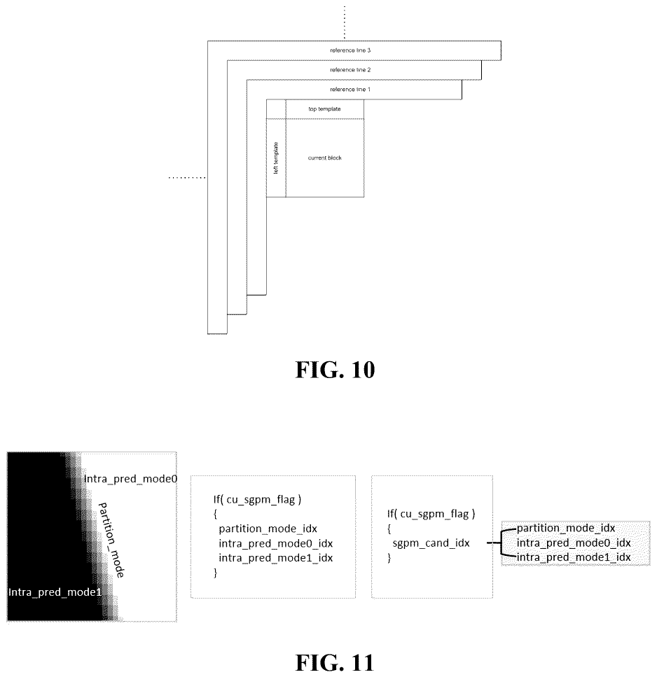

The TMRL candidate is constructed as follows. In some embodiments, there are M (for example, 5×10=50) combinations of the extended reference line and the allowed intra-prediction modes for a block. Since the extended reference line starts from reference line 1, the area covered by reference line 0 is used for template matching, where M is a positive integer number. FIG. 10 is a schematic diagram illustrating an exemplary L shaped neighborhood for a given predicted block, according to some embodiments of the present disclosure. As shown in FIG. 10, the SAD costs over the template area are calculated between the predictions (e.g., generated by 50 combinations) and the reconstructions. Then, optimal N combinations with the least SAD cost are selected in an ascending order to form the TMRL candidate list, where N is a positive integer number and equal to or less than M, for example, N is 20.

For TMRL signaling instead of coding the reference line and the intra mode directly, an index to the TMRL candidate list is coded to indicate which combination of reference line and prediction mode is used for coding the current block.

In ECM, a spatial geometric partitioning mode (SGPM) is applied. SGPM is an intra mode that resembles the inter coding tool of GPM, where the two prediction parts are generated from intra predicted process. FIG. 11 is a schematic diagram illustrating exemplary spatial geometric partition mode (SGPM) candidates, according to some embodiments of the present disclosure. As shown in FIG. 11, in this mode, a candidate list is built with each entry containing one partition split and two intra prediction modes. 26 partition modes and 9 intra prediction modes are used to form the combinations. The length of the candidate list is set equal to 16, i.e., there are 16 candidates (e.g., intra modes) in the candidate list. In some embodiments, the length of the candidate list can be set to other positive integer number. An index indicating the selected candidate is signaled.

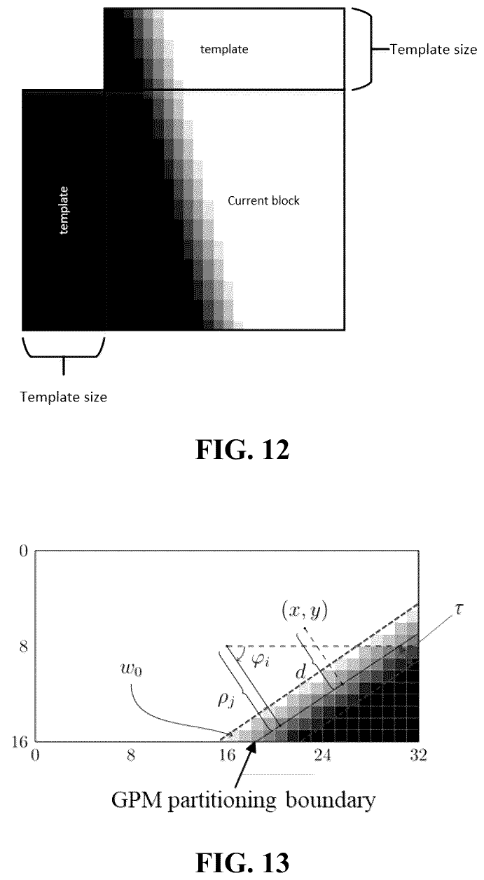

FIG. 12 is a schematic diagram illustrating exemplary GPM templates, according to some embodiments of the present disclosure. The list is reordered using template shown in FIG. 12, where SAD between the prediction and reconstruction of the template is used for ordering. The template size is fixed to 1.

For each partition mode, an IPM list is derived for each part using the same intra-inter GPM list derivation. The IPM list size is set to 3. In the list, TIMD derived mode is replaced by 2 derived modes with horizontal and vertical orientations. The list is further augmented with block-vector based prediction candidates obtained from the adjacent and non-adjacent merge candidates coded in Intra TMP or IBC mode. The template cost is employed to select the up to 6 block vectors. The final list contains up to 9 predictors: 3 regular intra modes and up to 6 block vectors-based predictors.

The SGPM mode is applied with a restricted blocks size: 4<=width<=64, 4<=height<=64, width<height×8, height<width×8, width×height>=32.

A PPS flag is coded to indicate whether no blending of two intra predictions is allowed. FIG. 13 is a schematic diagram illustrating an exemplary GPM blending process, according to some embodiments of the present disclosure. When this PPS flag is set to false, the following adaptive blending is also used for spatial GPM, where blending depth τ shown in FIG. 13 is derived as follows:
If min (width, height)==4, ½ τ is selected
else if min (width, height)==8, τ is selected
else if min (width, height)==16, 2 τ is selected
else if min (width, height)==32, 4 τ is selected
else, 8 τ is selected.

Otherwise (the PPS flag is set to true), ¼ τ is always used for SGPM coded blocks to make sure no blending is used when SGPM block has partition angle completely horizontal or vertical, and much narrower blending width is used when SGPM block has other partition angles. It is noted that the flag is set to true in current Common Test Conditions (CTC) for the screen content videos.

Intra prediction fusion is an intra prediction method that derives predicted samples as a weighted combination of multiple predictors generated from different reference lines. In this process, multiple intra predictors are generated and then fused by weighted averaging. The process of deriving the predictors to be used in the fusion process is described as follows:

1) For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊₁ is the prediction from the line above the default reference line. The weights are set as w₀=¾ and w₁=¼.

2) For TIMD mode with blending, pₗᵢₙₑ is used for the first mode (w₀=1, w₁=0) and pₗᵢₙₑ₊₁ is used for the second mode (w₀=0, w₁=1).

3) For DIMD mode with blending, the number of predictors selected for a weighted average is increased from 3 to 6.

The angular intra prediction fusion method is applied to luma blocks when angular intra mode has non-integer slope (required reference samples interpolation) and the block size is greater than 16, it is used with MRL and not applied for ISP coded blocks. PDPC is applied for the intra prediction mode using the closest to the current block reference line.

The TIMD mode with blending method is applied when all the following conditions are satisfied:
both the first and second modes are angular prediction mode
the current block is not ISP coded block.
all of the following conditions are false:
   abs (predModeIntra1−predModeIntra2) is greater than Threshold. The value of Threshold is set to 8 or 4 depending on block size.

```
  −(predModeIntra1 − EXT_HOR_IDX) ×(predModeIntra2 −
EXT_HOR_IDX) is less than 0.
  −(predModeIntra1 − EXT_VER_IDX) ×(predModeIntra2 −
EXT_VER_IDX) is less than 0.
```

Reference sample interpolation and smoothing for intra-prediction are also described.

In VVC, the mode dependent intra reference sample smoothing (MDIS) condition is applied to determine the filter used in the intra prediction process. Specifically, four-tap intra interpolation filters are utilized to improve the directional intra prediction accuracy. In HEVC, a two-tap linear interpolation filter has been used to generate the intra prediction block in the directional prediction modes (i.e., excluding Planar and DC predictors). In VVC, the two sets of 4-tap interpolation filters replace lower precision linear interpolation as in HEVC, where one is a DCT-based interpolation filter (DCTIF) and the other one is a 4-tap smoothing interpolation filter (SIF). The DCTIF is constructed in the same way as the one used for chroma component motion compensation in both HEVC and VVC. The SIF is obtained by convolving the 2-tap linear interpolation filter with [1 2 1]/4 filter.

Depending on the intra prediction mode, the following reference samples processing is performed:
The directional intra-prediction mode is classified into one of the following groups:
   Group A: vertical or horizontal modes (HOR_IDX, VER_IDX),
   Group B: directional modes that represent non-fractional angles (−14,−12,−10, −6, 2, 34, 66, 72, 76, 78, 80) and Planar mode,
   Group C: remaining directional modes;
If the directional intra-prediction mode is classified as belonging to group A, then then no filters are applied to reference samples to generate predicted samples;
Otherwise, if a mode falls into group B and the mode is a directional mode, and all of following conditions are true, then a [1, 2, 1] reference sample filter may be applied (depending on the MDIS condition) to reference samples to further copy these filtered values into an intra predictor according to the selected direction, but no interpolation filters are applied:

-refIdx is equal to 0 (no MRL)
-TU size is greater than 32
-Luma
-No ISP block

Otherwise, if a mode is classified as belonging to group C, MRL index is equal to 0, and the current block is not ISP block, then only an intra reference sample interpolation filter is applied to reference samples to generate a predicted sample that falls into a fractional or integer position between reference samples according to a selected direction (no reference sample filtering is performed). The interpolation filter type is determined as follows:

```
  −Set minDistVerHor equal to Min(Abs( predModeIntra − VER_IDX ),
Abs( predModeIntra − HOR_IDX))
  -Set nTbS equal to (Log2 (W) + Log2 (H)) >> 1
```

Set intraHorVerDistThres[nTbS] as specified below Table 1:

| | nTbS = 2 | nTbS = 3 | nTbS = 4 | nTbS = 5 | nTbS = 6 | nTbS = 7 |
|---|---|---|---|---|---|---|
| intraHorVerDistThres[nTbS] | 24 | 14 | 2 | 0 | 0 | 0 |

If minDistVerHor is greater than intraHorVerDistThres[nTbS], SIF is used for the interpolation
Otherwise, DCTIF is used for the interpolation
   where intraHorVerDistThres[nTbS] is an array of threshold used for interpolation filter selection, and nTbS indicates a transform block size index. For example, when nTbs equals to 4, the threshold for interpolation filter selection is set as 2. According to Table 1, for example, for a block having a 16×16 size, nTbS equals to 4, if the difference between the intra prediction mode index and either the horizontal mode index or vertical mode index is greater than 2, the SIF is used for interpolation. Otherwise, DCTIF is used.

In ECM, the 4-tap cubic interpolation is replaced with a 6-tap cubic interpolation filter for the derivation of predicted samples from the reference samples.

For reference sample filtering, a 6-tap gaussian filter is applied for larger blocks (W>=32 and H>=32), existing VVC 4-tap gaussian interpolation filter is applied otherwise. The extended intra reference samples are derived using the 4-tap interpolation filter instead of the nearest neighbor rounding.

The current design of intra prediction still has some problems. For example, in the current ECM, a manually crafted MDIS condition is employed to select the interpolation filter for angular intra prediction. However, this fixed design filter selection criterion may not necessarily always be optimal for ECM with newly adopted coding tools, thereby constraining the coding efficiency.

Embodiments of the present discloses provide methods for improving coding performance without increasing the complexity of encoding and decoding. Embodiments of the present disclosure also provide methods for selecting intra filter using rate-distortion optimization (RDO) criteria at the encoder side, with additional flag bits transmitted to indicate the filter type, thereby improving coding performance. Embodiments of the present disclosure further provide methods for selecting intra filter based on template matching (TM) cost, since the template matching (TM) is widely used in current ECM as an efficient coding tool to derive mode information based on the spatial correlation between the neighbor template regions and the current coding block area, thereby improving the coding performance.

The fixed nature of intra filter selection criterion in current ECM lacks the requisite flexibility and adaptability for different coding mode and diverse image content, thereby constraining the coding efficiency. In this disclosure, some modifications of the intra filter selection are proposed to improve the coding performance.

In the current TIMD design, angular intra prediction modes are extended from 67 to 131, the MDIS condition for TIMD is the same as previously described in Table 1, except that the mode index is mapped from 67 to 131 as follows:

$$mode = ( mode > 1 ) ? ( mode < 2 ? mode : ( ( mode << 1 ) - 2 ) ) : mode .$$

For example, the threshold (i.e., intraHorVerDistThres[nTbS]) is changed as below Table 2:

| | nTbS = 2 | nTbS = 3 | nTbS = 4 | nTbS = 5 | nTbS = 6 | nTbS = 7 |
|---|---|---|---|---|---|---|
| intraHorVerDistThres[ nTbS ] | 48 | 28 | 4 | 0 | 0 | 0 |

Compared with Table 1, the threshold is doubled for nTbS being 2, 3, and 4, because the angular intra prediction modes are extended from 67 to 131 for TIMD.

Embodiments of the present disclose provide methods for modifying MDIS condition for TIMD or DMID modes.

In some embodiments, it is proposed to modify the threshold (i.e., intraHorVerDistThres[nTbS]) in MDIS condition for TIMD mode as below Table 3:

| | nTbS = 2 | nTbS = 3 | nTbS = 4 | nTbS = 5 | nTbS = 6 | nTbS = 7 |
|---|---|---|---|---|---|---|
| intraHor VerDistThres[ nTbS ] | 48 | 48 | 28 | 0 | 0 | 0 |

In this example, the threshold is set greater than the threshold in original MDIS condition (shown in Table 1) for a block size of 8×8 or 16×16.

In some embodiments, the modification can be conditionally enabled based on the block size and the fusion mode of TIMD mode.

For example, after determining the angular intra modes for intra prediction using the TM method in TIMD mode, the original threshold (i.e., intraHorVerDistThres[nTbS]) can be entirely replaced by the proposed one or partially replaced by the proposed one which is dependent on the block size and the number or weights of the fusion modes of TIMD mode. In some embodiments, as the TIMD can fusion more than one angular intra mode, the proposed MDIS condition can be only applied to some of the angular intra modes which are fused in the TIMD mode.

In some embodiments, it is proposed to modify the threshold (i.e., intraHorVerDistThres[nTbS]) in MDIS condition for DIMD mode as below Table 4:

| | nTbS = 2 | nTbS = 3 | nTbS = 4 | nTbS = 5 | nTbS = 6 | nTbS = 7 |
|---|---|---|---|---|---|---|
| intraHorVerDistThres[ nTbS ] | 14 | 2 | 0 | 0 | 0 | 0 |

In this example, the threshold is set smaller than the threshold in original MDIS condition (shown in Table 1).

In some embodiments, this modification can be conditionally enabled based on the block size and the fusion mode of DIMD mode.

For example, after determining the angular intra modes based on texture gradient analysis in DIMD mode, the original threshold (i.e., intraHorVerDistThres[nTbS]) can be entirely replaced by the proposed one or partially replaced by the proposed one which is dependent on the block size and the number or weights of the fusion modes of DIMD mode. In some embodiments, as the TIMD can fusion more than one angular intra mode, this MDIS condition can be only applied to some of the angular intra modes which are fused in the DIMD mode.

In some embodiments, MDIS condition is proposed to use on the template for TM-based coding tools, such as TIMD, DIMD, TMRL, SGPM, etc.

In some embodiments, different from the current ECM design which always uses 4-tap cubic interpolation filter for angular intra prediction on the template region, the MDIS condition for intra filter selection can be applied to the template region. In some embodiments, the intra filter used in the template region is consistent with the intra filter used for the current block.

In some embodiments, both the filter length and the filter tap coefficients applied on the template region and current coding block are the same. In some embodiments, only the filter type applied on the template region and current coding block are the same, while the filter tap and the filter tap coefficients can be different.

Generally, allowing the encoder to select the intra filter through the rate-distortion optimization (RDO) process can determine the optimal intra filter for each traditional angular intra mode. However, this approach incurs a high signaling overhead, thus failing to achieve better trade-off between bitrate and distortion. Comparing with the signaling overhead of the original 67 modes, the signaling overhead of the newly added intra prediction modes in the current ECM the angular intra mode is reduced, therefore, it is possible to obtain coding gains by choosing intra filters based on an RDO process.

Embodiments of the present disclosure provide methods for RDO-based intra filter selection.

In some embodiments, the intra filter to be used (including gauss interpolation filter, cubic interpolation filter, etc.) is selected based on rate-distortion optimization at the encoder side, and an index indicating the optimal intra filter is encoded in the bitstream and signaled to the decoder side. Then, the decoder determines the intra filter by decoding the index from the bitstream.

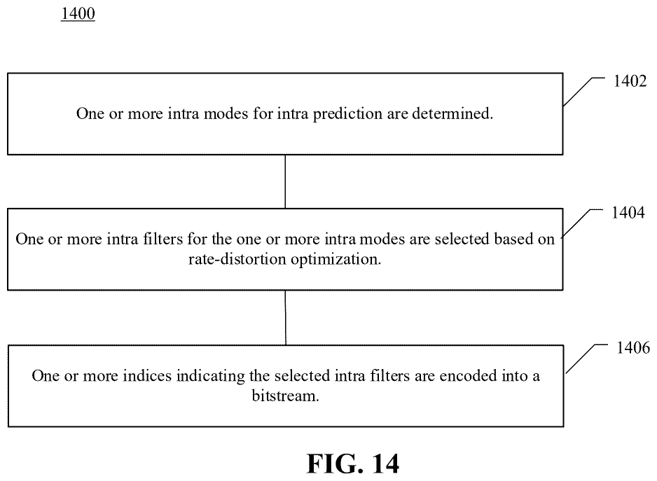

FIG. 14 is a flowchart of an exemplary method for intra filter selection, according to some embodiments of the present disclosure. Method 1400 can be performed by an encoder (e.g., by process 200A of FIG. 2A or 200B of FIG. 2B) or performed by one or more software or hardware components of an apparatus (e.g., apparatus 400 of FIG. 4). For example, a processor (e.g., processor 402 of FIG. 4) can perform method 1400. In some embodiments, method 1400 can be implemented by a computer program product, embodied in a computer-readable medium, including computer-executable instructions, such as program code, executed by computers (e.g., apparatus 400 of FIG. 4). Referring to FIG. 14, method 1400 may include the following steps 1402 to 1406.

At step 1402, one or more intra prediction modes for intra prediction are determined.

At step 1404, one or more intra filters for the one or more intra modes are selected based on RDO. In some embodiments, one or more RDO tests using different intra filter combinations are performed to determine an optimal combination. A combination including one or more intra filters is determined to be the optimal combination when the rate-distortion cost of this combination is the smallest among all the combinations. The intra filters in the optimal combination are determined as the selected intra filters. In some embodiments, a plurality of RDO tests using different intra filters are performed on each of the one or more intra prediction mode, respectively. Then, for each intra prediction mode, an optimal intra filter is selected.

At step 1406, one or more indices indicating the selected intra filters are encoded into a bitstream and then signaled to a decoder.

In some embodiments, at step 1402, a plurality of angular intra modes for intra prediction using TM method in TIMD mode are determined. In some embodiments, method 1400 can be applied to DIMD modes, TMRL modes, SGPM modes, etc.

In some embodiments, more than one angular intra predictor are combined to form the final prediction result in the fusion mode, such as TIMD modes, DIMD modes, SGPM modes, Intra prediction fusion modes, etc. For these fusion modes, at step 1402, the one or more angular intra modes are determined based on fusion weights. For example, the one or more intra modes which have higher fusion weights than others are selected. In some embodiments, the most important intra mode which has the highest fusion weights is selected. In some embodiments, top N intra modes are selected, where N is a positive integer. Then, at step 1404, the RDO-based intra filter selection is performed on selected one or more intra modes. At step 1406, one or more indices are encoded into the bitstream to indicate the intra filters for the selected one or more angular intra modes.

In some embodiments, for the fusion modes such as TIMD modes, DIMD modes, SGPM modes, intra prediction fusion modes, etc., all the angular intra modes that need to be fusion together or weighted fusion together can use the same intra filter to reduce the signal overhead. In this example, step 1404 can be selectively bypassed. And at step 1406, one index is encoded into the bitstream to indicate in an intra filter for all the intra modes fused.

In some embodiments, at the decoder side, the decoder decodes the one or more indices and determines the one or more intra filters used for one or more angular intra modes for intra prediction.

Embodiments of the present disclosure also provides method for TM-based intra filter selection.

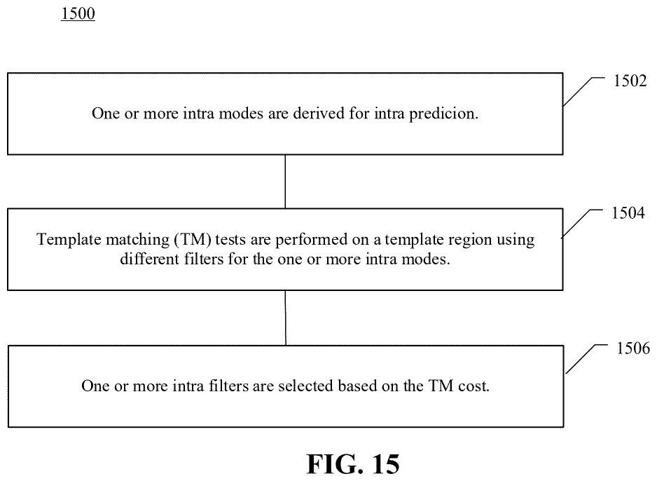

FIG. 15 is a flowchart of an exemplary method for TM-based intra filter selection, according to some embodiments of the present disclosure. Method 1500 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1500. In some embodiments, method 1500 can be implemented by a computer program product, embodied in a computer-readable medium, including computer-executable instructions, such as program code, executed by computers (e.g., apparatus 400 of FIG. 4). Referring to FIG. 15, method 1500 may include the following steps 1502 to 1506.

At step 1502, one or more intra modes are derived for intra prediction. In some embodiment, for a TIMD mode, the one or more angular intra modes are derived based on TM cost, and based on the one or more derived modes, a weighted fusion method can be used to generate the final predictor. In some embodiments, for a DIMD mode, the one or more angular intra modes are derived based on based on texture gradient analysis and based on the one or more derived modes, a weighted fusion method can be used to generate the final predictor. In some embodiments, for an SGPM mode, two angular intra prediction modes can be derived for two partitions in SGPM mode based on TM cost, and based on these derived modes, a weighted blending method can be used to generate the final predictor. In some embodiments, for a TMRL mode, there are M combinations, for example, 10 combinations (e.g., 5 reference line candidates combined with 10 angular intra modes) of the extended reference line and the allowed intra prediction modes for a block, where M is a positive integer. Referring back to FIG. 10, since the extended reference line starts from reference line 1, the area covered by reference line 0 (i.e., top template area and left template area as indicated in FIG. 10) is used for template matching. Then, N combinations with the least SAD cost are selected in an ascending order from the M combinations to form the TMRL candidate list, where N is equal to or less than M, for example, N is 20.

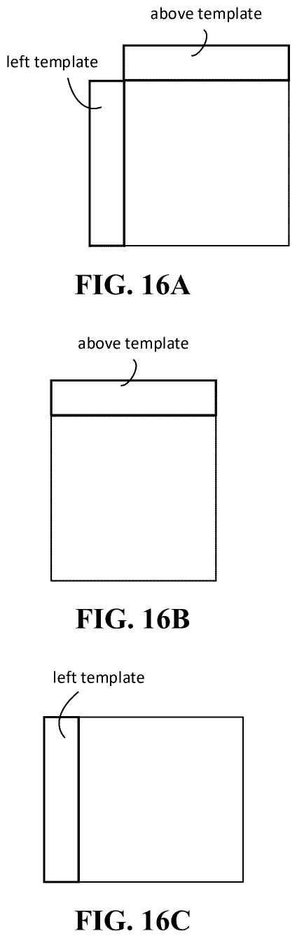

At step 1504, template matching (TM) tests are performed on a template region using different filters for the one or more intra modes. FIGS. 16A-16C illustrates different shapes of template regions, according to some embodiments. As shown in FIGS. 16A-16C, the template regions have three shapes including LEFT_ABOVE_TEMPLATE (in FIG. 16A), ABOVE_TEMPLATE (in FIG. 16B), and LEFT_TEMPLATE (in FIG. 16C). The width and the height of the template are both positive integers, for example, 1, 4, or other numbers. Angular intra prediction is performed on the template region using the derived angular intra mode with different intra filter. In some embodiments, several different filters can be grouped as a combination, and the TM tests are performed on the template region using different filter combinations. A filter combination comprises one or more intra filters.

At step 1506, one or more intra filters are selected based on the TM cost. For example, one or more intra filters in one combination with the smallest TM cost are selected as the optimal intra filters to replace the MDIS condition for the current coding block. The TM cost is calculated as the sum of absolute difference (SAD) or sum of absolute transformed difference (SATD) between the final predicted sample values and the reconstructed sample values of the template region. In some embodiments, for TMRL mode, the filter with the smallest TM cost is selected to replace the MDIS condition for the current coding block.

In some embodiments, method 1500 is used in TIMD mode, DIMD mode, SGPM mode, or TMRL mode, both at encoder and decoder, so that there is no need to additionally signal the index to indicate the intra filter.

In some embodiments, the TM-based intra filter selection can be conditionally enabled to replace the MDIS condition. For example, a final intra filter is determined to be the selected one or more intra filters or using MDIS condition. Then, intra prediction is performed on the coding block using the final intra filter.

In some embodiments, the TM-based intra filter selection can be conditionally enabled to replace the MDIS condition by setting a threshold for TM cost. For example, when the TM costs of all intra filter combinations are the same, the final intra filter is determined using MDIS condition. In some embodiments, when the TM cost of the optimal intra filter combination (e.g., the selected combination of intra filters) is higher than a (a float threshold number equal to or slightly less than 1, for example, greater than 0.9, such as 0.95, 0.98) times the TM cost obtained by the original MDIS condition (e.g., Table 1), the final intra filter is determined using the MDIS condition.

In some embodiments, the TM-based intra filter selection can be conditionally enabled to replace the MDIS condition by setting a threshold for block size. For example, the TM-based intra filter selection method (e.g., method 1500) can only be enabled when the block area (calculated as the production of width and the height of the current block, such as width×height, log 2(width×height), etc.) is in a range, for example, less than a first positive integer, or greater than a second positive integer.

In some embodiments, the TM-based intra filter selection can be conditionally enabled to replace the MDIS condition by setting conditions on the template shape. For example, the TM-based intra filter selection method (e.g., method 1500) can be enabled only when the template shape is LEFT_ABOVE_TEMPLATE as shown in FIG. 16A.

In some embodiments, when applying the TM-based intra filter selection method (e.g., method 1500) to the TIMD mode, to make better trade-off between the computational complexity and coding performance, intra prediction process can be simplified on the template regions. For example, the number of the filter taps can be reduced, the weighted blending process including location-dependent strategy used in TIMD mode (e.g., equations 10-13) can be removed.

In some embodiments, when applying the TM-based intra filter selection method (e.g., method 1500) in DIMD mode, to make better trade-off between the computational complexity and coding performance, intra prediction process can be simplified on the template regions. For example, the number of the filter taps can be reduced, the weighted blending process including location dependent blending used in DIMD mode (e.g., equations 7 and 8) can be removed.

In some embodiments, when applying the TM-based intra filter selection method (e.g., method 1500) in SGPM mode or TMRL mode, to make better trade-off between the computational complexity and coding performance, intra prediction process can be simplified on the template regions. For example, the number of filter taps can be reduced, and the intra prediction fusion mode can be removed.

In some embodiments, for applying the TM-based intra filter selection method (e.g., method 1500) to the TMRL mode, the template region used in method 1500 is the same as the template used in TMRL.

In some embodiments, the TM-based intra filter selection method can be applied in candidates list construction process, for example, for the candidates list construction in the SGPM or TMRL mode. Different methods can be used to combine the TM-based intra filter selection method with current candidate list construction process.

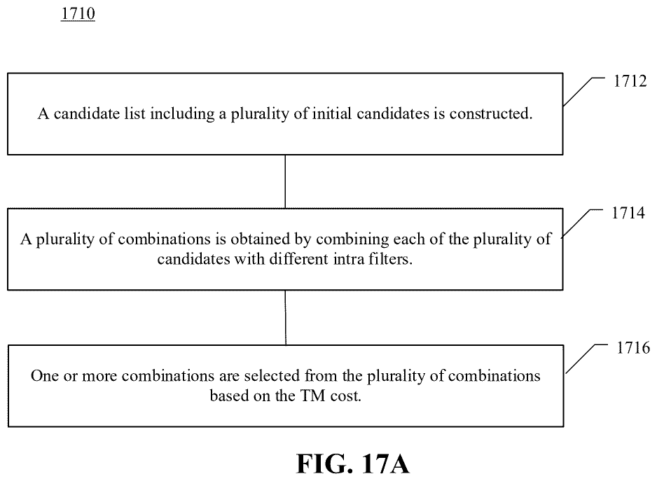

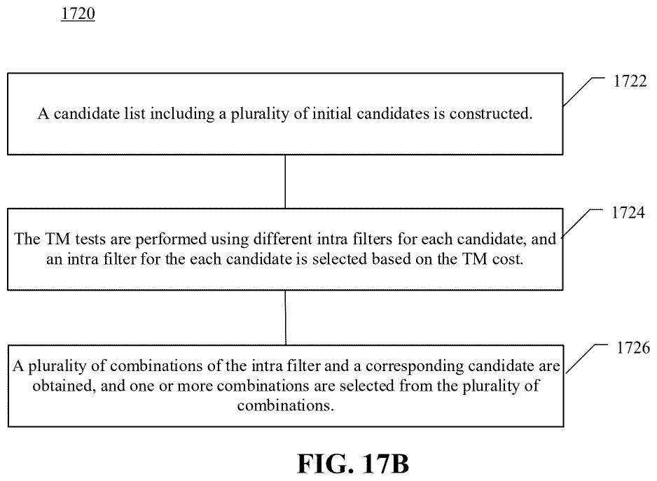

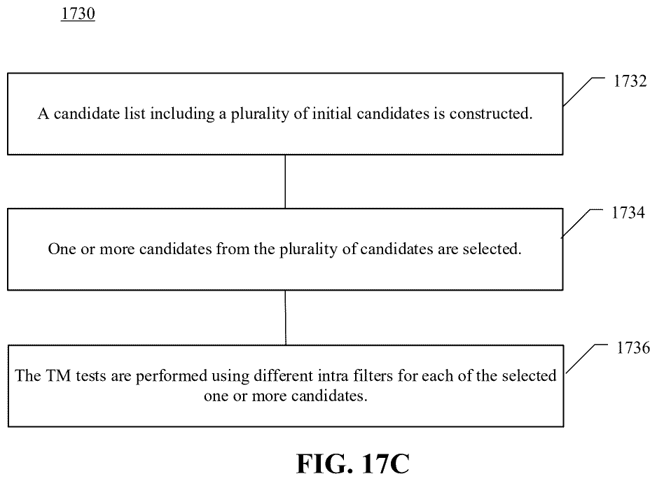

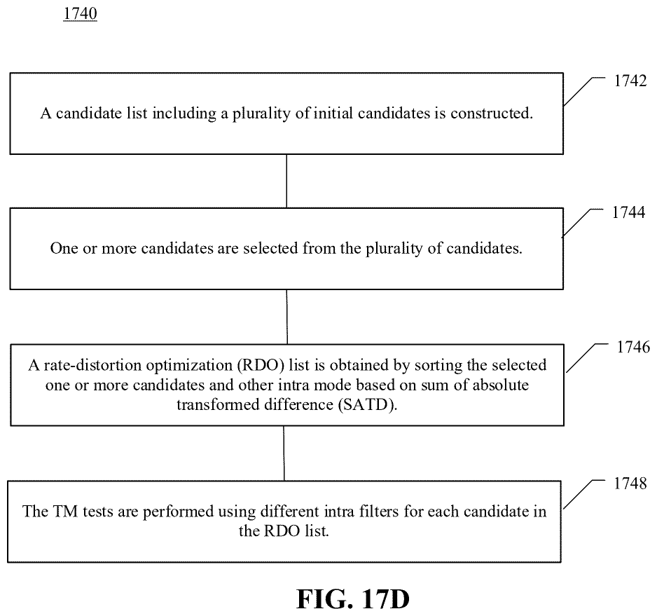

FIGS. 17A-17D are flowcharts of different exemplary processes of template matching (TM)-based intra filter selection for spatial geometric partition mode (SGPM) candidates list construction, according to some embodiments of the present disclosure. Methods 1710 to 1740 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform methods 1710 to 1740. In some embodiments, Methods 1710 to 1740 can be implemented by a computer program product, embodied in a computer-readable medium, including computer-executable instructions, such as program code, executed by computers (e.g., apparatus 400 of FIG. 4).

Referring to FIG. 17A, method 1710 may include the following steps 1712 to 1716. At step 1712, a candidate list including a plurality of initial candidates is constructed. At step 1714, a plurality of combinations is obtained by combining each of the plurality of candidates with different intra filters. At step 1716, one or more combinations are selected from the plurality of combinations based on the TM cost.

In some embodiments, for SGPM mode, initial N SGPM mode candidates list is constructed, where N is a positive integer number. Then, each of the initial N mode candidates is combined with K different intra filters to obtain M=N×K mode and filter combinations, where M and K are positive integer numbers. Then, the top L combinations from the M combinations are selected based on TM cost. Therefore, the candidate list is constructed with the L combinations.

Then, for determining a final prediction filter based on the candidate list obtained based on TM cost, a method can further include sorting all the selected combinations and other non-SGPM modes by SATD to obtain a RDO list; and performing a RDO process to obtain the final prediction filter.

In some embodiments, for TMRL mode, initial M candidates of TMRL are constructed, where M is a positive integer number, for example, M is 50. Then, the M candidates with different intra filters are obtained and sorted by TM-cost to select optimal N candidates, where N is a positive integer number and equal to or less than M, for example, N is 20. The N candidates and other intra prediction modes are sorted by SATD to obtain an RDO list. In some embodiments, when sorting and selecting the optimal N candidates, same angular intra mode and reference line with different intra filter type can be allowed or disallowed.

Referring to FIG. 17B, method 1720 may include the following steps 1722 to 1726. At step 1722, a candidate list including a plurality of initial candidates is constructed. At step 1724, the TM tests are performed using different intra filters for each candidate, and an intra filter for each candidate is selected based on the TM cost. At step 1726, a plurality of combinations of the intra filter and a corresponding candidate are obtained, and one or more combinations are selected from the plurality of combinations.

In some embodiments, for SGPM, an initial candidate list having N SGPM mode candidates is constructed. Then, for each of the SGPM mode candidates, one intra filter is selected from K different intra filters based TM cost. Therefore, the number of combinations is kept as N. Then top L combinations are selected from these N combinations based on TM cost, wherein L is a positive integer, for example, L is 16.

Then, for determining a final prediction filter based on the candidate list obtained based on TM cost, a method can further include sorting all the selected combinations and other non-SGPM modes by SATD to obtain a RDO list; and performing a RDO process to obtain the final prediction filter.

In some embodiments, for TMRL mode, initial M candidates of TMRL are constructed, where M is a positive integer number, for example, M is 50. Then, optimal N candidates are obtained by the original process in TMRL, i.e., the optimal N candidates with the least SAD cost are selected in an ascending order to form M candidates in the TMRL candidate list. Then, the TM-based intra filter selection process (e.g., method 1500) is applied for each of the N candidates to select a filter for each of the N candidate respectively.

Referring to FIG. 17C, method 1730 may include the following steps 1732 to 1736. At step 1732, a candidate list including a plurality of initial candidates is constructed. At step 1734, one or more candidates from the plurality of candidates are selected. At step 1736, the TM tests are performed using different intra filters for each of the selected one or more candidates.

In some embodiments, for SGPM, initial N SGPM mode candidates list is constructed, each candidate list has a fixed default intra filter. Then, top L SGPM mode candidates with default filter are selected by TM cost from N mode candidates, wherein L is a positive integer, for example, L is 16. For each of the L SGPM mode candidates, one intra filter is selected from K different filters. Therefore, L SGPM mode candidates are obtained, and different modes may have different intra filters.

Then, for determining a final prediction filter based on the candidate list obtained based on TM cost, a method can further include sorting the top P SGPM mode candidates and other non-SGPM modes by SATD to obtain a RDO list; and performing a RDO process to obtain the final prediction filter.

In some embodiments, the TM-based intra filter selection process (e.g., method 1500) is only performed for the candidates in a final RDO-list. Referring to FIG. 17D, method 1740 may include the following steps 1742 to 1748. At step 1742, a candidate list including a plurality of initial candidates is constructed. At step 1744, one or more candidates are selected from the plurality of candidates. At step 1746, a rate-distortion optimization (RDO) list is obtained by sorting the selected one or more candidates and other intra mode based on sum of absolute transformed difference (SATD). At step 1748, the TM tests are performed using different intra filters for each candidate in the RDO list.

In some embodiments, for SGPM, initial N SGPM mode candidates list is constructed, each candidate list has a fixed default intra filter. Then, top L SGPM modes with default filter are selected by TM cost from N mode candidates, where L is a positive integer number. In some embodiments, a default intra filter can be used for each candidate to have a TM cost. Then, all the filters including the top L SGPM mode candidates with default filter and other intra modes are sorted by SATD to obtain an RDO-list. In some embodiments, a default intra filter is used for SGPM mode candidates to obtain an RD cost. An intra filter for each SGPM mode that is in the RDO-list is selected based on TM cost.

Then, for determining a final prediction filter based on the candidate list obtained based on TM cost, a method can further include performing a RDO process to obtain the final prediction filter.

In some embodiments, for TMRL mode, an RDO-list is obtained by the original process in TMRL. The RDO-list may include some of the N candidates or some other intra prediction modes. The TM-based intra filter selection process (e.g., method 1500) is performed on the final RDO-list to select one or more filters for the candidates in the RDO-list.

The embodiments described in the present disclosure can be freely combined.

In some embodiments, a non-transitory computer readable medium storing a bitstream is provided. The bitstream is generated by receiving a video sequence and encoding the video sequence to generate coded information included in the bitstream. The bitstream can be transmitted to a decoder for decoding. The video sequence is encoded by the above-described methods.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

The embodiments may further be described using the following clauses:

1. A method of encoding a video sequence, the method comprising:
receiving a video sequence;
encoding the video sequence by:
   deriving one or more intra modes for intra prediction;
   performing template matching (TM) tests on a template region using different filters for the one or more intra modes; and
   selecting one or more intra filters based on a TM cost.

2. The method according to clause 1, wherein performing the tests using different filters further comprises:
performing the tests on the template region using different filter combinations, wherein a filter combination comprises one or more intra filters; and
selecting one or more intra filters based on the TM cost further comprises:
selecting one or more intra filters in an optimal combination, wherein the optimal combination comprises one or more intra filters, and a TM cost of the one or more intra filters in the optimal combination is the smallest among all the combinations.

3. The method according to clause 2, wherein a TM cost is calculated as a sum of absolute difference (SAD) or a sum of absolute transformed difference (SATD) between final predicted sample values and reconstructed sample values of the template region using the one or more intra filters in one combination.

4. The method according to clause 1, wherein selecting the one or more intra filters based on the TM cost is performed for candidate list construction for a coding block.

5. The method according to clause 4, wherein deriving one or more angular intra modes further comprises:
constructing a candidate list comprising a plurality of candidates; and
obtaining a plurality of combinations by combining each of the plurality of candidates with different intra filters; and
performing the TM tests on the template region using different intra filters further comprises:
performing the TM tests using the plurality of combinations; and
selecting one or more intra filters based on the TM cost further comprises:
selecting one or more combinations from the plurality of combinations based on the TM cost.

6. The method according to clause 4, wherein deriving one or more angular intra modes further comprises:
constructing a candidate list comprising a plurality of candidates;
performing the TM tests on the template region using different intra filters further comprises:
performing the TM tests using different intra filters for each candidate; and
   selecting one or more intra filters based on the TM cost further comprises:
selecting an intra filter for the each candidate based on the TM cost;
obtaining a plurality of combinations of the intra filter and a corresponding candidate; and
selecting one or more combinations from the plurality of combinations.

7. The method according to clause 4, wherein deriving one or more angular intra modes further comprises:
constructing a candidate list comprising a plurality of candidates; and
selecting one or more candidates from the plurality of candidates; and
performing the TM tests on the template region using different intra filters further comprises:
performing the TM tests using different intra filters for each of the selected one or more candidates.

8. The method according to clause 4, wherein deriving one or more angular intra modes further comprises:
constructing a candidate list comprising a plurality of candidates;
selecting one or more candidates from the plurality of candidates; and
obtaining a rate-distortion optimization (RDO) list by sorting the selected one or more candidates and other intra mode based on sum of absolute transformed difference (SATD); and
performing the TM tests on the template region using different intra filters further comprises:
performing the TM tests using different intra filters for each candidate in the RDO list.

9. The method according to clause 4, wherein the coding block is coded using a spatial geometric partition mode (SGPM) or a template-based multiple reference line intra prediction (TMRL) mode.

10. The method according to clause 1, wherein deriving one or more intra modes further comprises deriving one or more intra modes for a coding block, and the encoding further comprising:
performing the intra prediction using the selected one or more intra filters.

11. The method according to clause 10, wherein the coding block is coded using a template-based intra mode derivation (TIMD) mode, and deriving one or more intra modes for the coding block further comprises:
deriving the one or more intra modes based on a TM cost.

12. The method according to clause 10, wherein the coding block is coded using a decoder-side intra mode derivation (DIMD) mode, and deriving one or more angular intra modes for a coding block further comprises:
deriving the one or more angular intra modes based on texture gradient analysis.

13. The method according to clause 10, wherein the coding block is coded using a spatial geometric partition mode (SGPM), and deriving one or more angular intra modes for a coding block further comprises:
deriving two angular intra modes for two partitions in the SGPM mode based on a TM cost.

14. The method according to clause 10, wherein the coding block is coded using a template-based multiple reference line intra prediction (TMRL) mode, and deriving one or more angular intra modes for a coding block further comprises:
sorting a plurality of combinations in a TMRL candidate list in an ascending order based on a sum of absolute difference (SAD) cost, one combination comprising a reference line candidate and an angular intra mode; and
selecting one or more combinations with the least SAD cost from the TMRL candidate list.

15. The method according to clause 10, wherein the encoding further comprises:
determining a final intra filter to be the selected one or more intra filter or using mode dependent intra reference sample smoothing (MDIS) condition.

16. The method according to clause 15, wherein determining the final intra filter to be the selected one or more intra filter or using the MDIS condition further comprises:
in response to the TM cost for all combinations is equal, determining the final intra filter using the MDIS condition.

17. The method according to clause 15, wherein determining the final intra filter to be the selected one or more intra filter or using the MDIS condition is based on a threshold, and determining the final intra filter to be the selected one or more intra filter or using the MDIS condition further comprises:
obtaining a TM cost for intra filter selected using the MDIS condition;
in response to a ratio of the TM cost of the selected one or more intra filters to the TM cost for intra filter selected using the MDIS condition being greater than the threshold, determining the final intra filter using the MDIS condition, wherein the threshold is equal to or smaller than 1.

18. The method according to clause 15, wherein determining the final intra filter to be the selected one or more intra filters or using the MDIS condition is based on an area of the coding block, wherein determining the final intra filter to be the selected one or more intra filters or using the MDIS condition comprises:
in response to an area of the coding block being in a range, determining the final intra filter to be the selected one or more intra filters.

19. The method according to clause 15, wherein determining the final intra filter to be the selected one or more intra filters or using the MDIS condition is based on a template shape of the coding block, and determining the final intra filter to be the selected one or more intra filter or using the MDIS condition further comprises:
determining the template shape of the coding block;
in response to the template shape comprising a left template and an above template, determining the final intra filter to be the selected one or more intra filters.

20. A method of encoding a video sequence, the method comprising:
receiving a video sequence;
encoding the video sequence by:
   determining a coding mode for a coding block and a block size of the coding block, wherein the coding mode comprises a template-based intra mode derivation (TIMD) mode or a decoder-side intra mode derivation (DIMD) mode;
   determining a distance between an intra mode of the coding block and a horizontal prediction mode or a vertical prediction mode;
   selecting an intra filter based on the coding mode, the block size, and the distance; and
      performing intra prediction on the coding block using the selected intra filter.

21. The method according to clause 20, wherein selecting an intra filter based on the coding mode, the block size, and the distance further comprises:
determining a threshold corresponding to the coding mode and the block size;
comparing the distance and the threshold;
in response to the distance being greater than the threshold, determining a smoothing interpolation filter (SIF) to be the intra filter;
in response to the distance being equal to or smaller than the threshold, determining a discrete cosine transform-based interpolation filter (DCTIF) to be the intra filter.

22. A method of encoding a video sequence, the method comprising:
receiving a video sequence;
encoding the video sequence by:
   selecting an intra filter for a template region of a coding block based on MDIS condition; and
   performing intra prediction on the template region using the selected intra filter.

23. The method according to clause 22, wherein the selected intra filter is a first intra filter, and the encoding further comprises:
selecting a second intra filter for the coding block based on the MDIS condition; wherein a filter length and a filter tap coefficients of the first intra filter and the second intra filter are the same.

24. The method according to clause 22, wherein the selected intra filter is a first intra filter, and the encoding further comprises:
selecting a second intra filter for the coding block based on MDIS condition; wherein at least one of a filter length and a filter tap coefficients of the first intra filter and the second intra filter are different.

25. A method of encoding a video sequence, the method comprising:
receiving a video sequence;
   encoding the video sequence by:
determining one or more angular intra modes for intra prediction;
selecting one or more intra filters for the one or more angular intra modes based on rate-distortion optimization (RDO); and
encoding one or more indices indicating the selected intra filters into a bitstream.

26. The method according to clause 25, wherein selecting one or more intra filters for the one or more angular intra modes based on RDO further comprises:
performing one or more RDO tests using different intra filter combinations on the one or more angular intra modes; and
selecting one or more intra filters in an optimal combination, wherein the optimal combination comprises one or more intra filters, and an RDO of the one or more intra filters in the optimal combination is the smallest among all the combinations.

27. The method according to clause 25, wherein determining one or more intra modes for intra prediction further comprises:
determining the one or more angular intra modes using a template matching (TM) method in a template-based intra mode derivation (TIMD) mode.

28. The method according to clause 25, wherein determining one or more angular intra modes for intra prediction further comprises:
determining one or more angular intra modes for the intra prediction based on fusing weights.

29. The method according to clause 25, the encoding further comprises:
determining whether the one or more angular intra are fused;
in response to the one or more angular intra modes are fused, selectively bypassing the selecting one or more intra filters for the one or more angular intra modes based on rate-distortion optimization (RDO); and
encoding one or more indices indicating the selected intra filters into a bitstream further comprises:
encoding an index indicating an intra filter for the fused one or more angular intra modes.

30. A method for decoding a bitstream, the method comprising:
receiving a bitstream; and
decoding the bitstream to output a video sequence, the decoding comprising:
   deriving one or more intra modes for intra prediction;
performing template matching (TM) tests on a template region using different filters for the one or more intra modes; and
selecting one or more intra filters based on a TM cost.

31. The method according to clause 30, wherein performing the tests using different filters further comprises:
performing the tests on the template region using different filter combinations, wherein a filter combination comprises one or more intra filters; and
   selecting one or more intra filters based on the TM cost further comprises:

selecting one or more intra filters in an optimal combination, wherein the optimal combination comprises one or more intra filters, and a TM cost of the one or more intra filters in the optimal combination is the smallest among all the combinations.

32. The method according to clause 31, wherein a TM cost is calculated as a sum of absolute difference (SAD) or a sum of absolute transformed difference (SATD) between final predicted sample values and reconstructed sample values of the template region using the one or more intra filters in one combination.

33. The method according to clause 30, wherein selecting the one or more intra filters based on the TM cost is performed for candidate list construction for a coding block.

34. The method according to clause 33, wherein deriving one or more angular intra modes further comprises:
constructing a candidate list comprising a plurality of candidates; and
obtaining a plurality of combinations by combining each of the plurality of candidates with different intra filters; and
performing the TM tests on the template region using different intra filters further comprises:
performing the TM tests using the plurality of combinations; and
   selecting one or more intra filters based on the TM cost further comprises:
selecting one or more combinations from the plurality of combinations based on the TM cost.

35. The method according to clause 33, wherein deriving one or more angular intra modes further comprises:
constructing a candidate list comprising a plurality of candidates;
performing the TM tests on the template region using different intra filters further comprises:
performing the TM tests using different intra filters for each candidate; and
   selecting one or more intra filters based on the TM cost further comprises:
selecting an intra filter for the each candidate based on the TM cost;
obtaining a plurality of combinations of the intra filter and a corresponding candidate; and
selecting one or more combinations from the plurality of combinations.

36. The method according to clause 33, wherein deriving one or more angular intra modes further comprises:
constructing a candidate list comprising a plurality of candidates; and
selecting one or more candidates from the plurality of candidates; and
   performing the TM tests on the template region using different intra filters further comprises:
performing the TM tests using different intra filters for each of the selected one or more candidates.

37. The method according to clause 33, wherein deriving one or more angular intra modes further comprises:
constructing a candidate list comprising a plurality of candidates;
selecting one or more candidates from the plurality of candidates; and
obtaining a rate-distortion optimization (RDO) list by sorting the selected one or more candidates and other intra mode based on sum of absolute transformed difference (SATD); and
performing the TM tests on the template region using different intra filters further comprises: performing the TM tests using different intra filters for each candidate in the RDO list.

38. The method according to clause 33, wherein the coding block is coded using a spatial geometric partition mode (SGPM) or a template-based multiple reference line intra prediction (TMRL) mode.

39. The method according to clause 30, wherein deriving one or more intra modes further comprises deriving one or more intra modes for a coding block, and the decoding further comprising:
performing the intra prediction using the selected one or more intra filters.

40. The method according to clause 39, wherein the coding block is coded using a template-based intra mode derivation (TIMD) mode, and deriving one or more intra modes for the coding block further comprises:
deriving the one or more intra modes based on a TM cost.

41. The method according to clause 39, wherein the coding block is coded using a decoder-side intra mode derivation (DIMD) mode, and deriving one or more angular intra modes for a coding block further comprises:
deriving the one or more angular intra modes based on texture gradient analysis.

42. The method according to clause 39, wherein the coding block is coded using a spatial geometric partition mode (SGPM), and deriving one or more angular intra modes for a coding block further comprises:
deriving two angular intra modes for two partitions in the SGPM mode based on a TM cost.

43. The method according to clause 39, wherein the coding block is coded using a template-based multiple reference line intra prediction (TMRL) mode, and deriving one or more angular intra modes for a coding block further comprises:
sorting a plurality of combinations in a TMRL candidate list in an ascending order based on a sum of absolute difference (SAD) cost, one combination comprising a reference line candidate and an angular intra mode; and
selecting one or more combinations with the least SAD cost from the TMRL candidate list.

44. The method according to clause 39, wherein the decoding further comprises:
determining a final intra filter to be the selected one or more intra filter or using mode dependent intra reference sample smoothing (MDIS) condition.

45. The method according to clause 44, wherein determining the final intra filter to be the selected one or more intra filter or using the MDIS condition further comprises:
in response to the TM cost for all combinations is equal, determining the final intra filter using the MDIS condition.

46. The method according to clause 44, wherein determining the final intra filter to be the selected one or more intra filter or using the MDIS condition is based on a threshold, and determining the final intra filter to be the selected one or more intra filter or using the MDIS condition further comprises:
obtaining a TM cost for intra filter selected using the MDIS condition;
in response to a ratio of the TM cost of the selected one or more intra filters to the TM cost for intra filter selected using the MDIS condition being greater than the threshold, determining the final intra filter using the MDIS condition, wherein the threshold is equal to or smaller than 1.

47. The method according to clause 44, wherein determining the final intra filter to be the selected one or more intra filters or using the MDIS condition is based on an area of the coding block, wherein determining the final intra filter to be the selected one or more intra filters or using the MDIS condition comprises:
in response to an area of the coding block being in a range, determining the final intra filter to be the selected one or more intra filters.

48. The method according to clause 44, wherein determining the final intra filter to be the selected one or more intra filters or using the MDIS condition is based on a template shape of the coding block, and determining the final intra filter to be the selected one or more intra filter or using the MDIS condition further comprises:
determining the template shape of the coding block;
in response to the template shape comprising a left template and an above template, determining the final intra filter to be the selected one or more intra filters.

49. A method for decoding a bitstream, the method comprising:
receiving a bitstream; and
   decoding the bitstream to output a video sequence, the decoding comprising:
determining a coding mode for a coding block and a block size of the coding block, wherein the coding mode comprises a template-based intra mode derivation (TIMD) mode or a decoder-side intra mode derivation (DIMD) mode;
determining a distance between an intra mode of the coding block and a horizontal prediction mode or a vertical prediction mode;
selecting an intra filter based on the coding mode, the block size, and the distance; and
performing intra prediction on the coding block using the selected intra filter.

50. The method according to clause 49, wherein selecting an intra filter based on the coding mode, the block size, and the distance further comprises:
determining a threshold corresponding to the coding mode and the block size;
comparing the distance and the threshold;
in response to the distance being greater than the threshold, determining a smoothing interpolation filter (SIF) to be the intra filter;
in response to the distance being equal to or smaller than the threshold, determining a discrete cosine transform-based interpolation filter (DCTIF) to be the intra filter.

51. A method for decoding a bitstream, the method comprising:
receiving a bitstream; and
   decoding the bitstream to output a video sequence, the decoding comprising:
selecting an intra filter for a template region of a coding block based on MDIS condition; and
performing intra prediction on the template region using the selected intra filter.

52. The method according to clause 51, wherein the selected intra filter is a first intra filter, and the decoding further comprises:
selecting a second intra filter for the coding block based on the MDIS condition; wherein a filter length and a filter tap coefficients of the first intra filter and the second intra filter are the same.

53. The method according to clause 51, wherein the selected intra filter is a first intra filter, and the decoding further comprises:
selecting a second intra filter for the coding block based on MDIS condition; wherein at least one of a filter length and a filter tap coefficients of the first intra filter and the second intra filter are different.

54. A method for decoding a bitstream, the method comprising:
receiving a bitstream; and
decoding the bitstream to output a video sequence, the decoding comprising:
determining one or more angular intra modes for intra prediction;
selecting one or more intra filters for the one or more angular intra modes based on rate-distortion optimization (RDO); and
decoding one or more indices indicating the selected intra filters.

55. The method according to clause 54, wherein selecting one or more intra filters for the one or more angular intra modes based on RDO further comprises:
performing one or more RDO tests using different intra filter combinations on the one or more angular intra modes; and
selecting one or more intra filters in an optimal combination, wherein the optimal combination comprises one or more intra filters, and an RDO of the one or more intra filters in the optimal combination is the smallest among all the combinations.

56. The method according to clause 54, wherein determining one or more intra modes for intra prediction further comprises:
determining the one or more angular intra modes using a template matching (TM) method in a template-based intra mode derivation (TIMD) mode.

57. The method according to clause 54, wherein determining one or more angular intra modes for intra prediction further comprises:
determining one or more angular intra modes for the intra prediction based on fusing weights.

58. The method according to clause 54, the decoding further comprises:
determining whether the one or more angular intra modes are fused;
in response to the one or more angular intra modes are fused, selectively bypassing the selecting one or more intra filters for the one or more angular intra modes based on rate-distortion optimization (RDO); and
   decoding one or more indices indicating the selected intra filters further comprises:
   decoding an index indicating an intra filter for the fused one or more angular intra modes.

59. A method for signaling a bitstream, the method comprising:
receiving a video sequence;
   encoding the video sequence by:
deriving one or more intra modes for intra prediction;
performing template matching (TM) tests on a template region using different filters for the one or more intra modes; and
selecting one or more intra filters based on a TM cost; and
signaling a bitstream that is generated based on the encoding.

60. The method according to clause 59, wherein performing the tests using different filters further comprises:
performing the tests on the template region using different filter combinations, wherein a filter combination comprises one or more intra filters; and
   selecting one or more intra filters based on the TM cost further comprises:
selecting one or more intra filters in an optimal combination, wherein the optimal combination comprises one or more intra filters, and a TM cost of the one or more intra filters in the optimal combination is the smallest among all the combinations.

61. The method according to clause 60, wherein a TM cost is calculated as a sum of absolute difference (SAD) or a sum of absolute transformed difference (SATD) between final predicted sample values and reconstructed sample values of the template region using the one or more intra filters in one combination.

62. The method according to clause 59, wherein selecting the one or more intra filters based on the TM cost is performed for candidate list construction for a coding block.

63. The method according to clause 62, wherein deriving one or more angular intra modes further comprises:
constructing a candidate list comprising a plurality of candidates; and
obtaining a plurality of combinations by combining each of the plurality of candidates with different intra filters; and
   performing the TM tests on the template region using different intra filters further comprises:
performing the TM tests using the plurality of combinations; and
   selecting one or more intra filters based on the TM cost further comprises:
selecting one or more combinations from the plurality of combinations based on the TM cost.

64. The method according to clause 62, wherein deriving one or more angular intra modes further comprises:
constructing a candidate list comprising a plurality of candidates;
   performing the TM tests on the template region using different intra filters further comprises: performing the TM tests using different intra filters for each candidate; and
   selecting one or more intra filters based on the TM cost further comprises:
selecting an intra filter for the each candidate based on the TM cost;
obtaining a plurality of combinations of the intra filter and a corresponding candidate; and
selecting one or more combinations from the plurality of combinations.

65. The method according to clause 62, wherein deriving one or more angular intra modes further comprises:
constructing a candidate list comprising a plurality of candidates; and
selecting one or more candidates from the plurality of candidates; and
   performing the TM tests on the template region using different intra filters further comprises:
performing the TM tests using different intra filters for each of the selected one or more candidates.

66. The method according to clause 62, wherein deriving one or more angular intra modes further comprises:
constructing a candidate list comprising a plurality of candidates;
selecting one or more candidates from the plurality of candidates; and
obtaining a rate-distortion optimization (RDO) list by sorting the selected one or more candidates and other intra mode based on sum of absolute transformed difference (SATD); and
   performing the TM tests on the template region using different intra filters further comprises:
performing the TM tests using different intra filters for each candidate in the RDO list.

67. The method according to clause 62, wherein the coding block is coded using a spatial geometric partition mode (SGPM) or a template-based multiple reference line intra prediction (TMRL) mode.

68. The method according to clause 59, wherein deriving one or more intra modes further comprises deriving one or more intra modes for a coding block, and the encoding further comprising:

performing the intra prediction using the selected one or more intra filters.

69. The method according to clause 68, wherein the coding block is coded using a template-based intra mode derivation (TIMD) mode, and deriving one or more intra modes for the coding block further comprises:
deriving the one or more intra modes based on a TM cost.

70. The method according to clause 68, wherein the coding block is coded using a decoder-side intra mode derivation (DIMD) mode, and deriving one or more angular intra modes for a coding block further comprises:
deriving the one or more angular intra modes based on texture gradient analysis.

71. The method according to clause 68, wherein the coding block is coded using a spatial geometric partition mode (SGPM), and deriving one or more angular intra modes for a coding block further comprises:
deriving two angular intra modes for two partitions in the SGPM mode based on a TM cost.

72. The method according to clause 68, wherein the coding block is coded using a template-based multiple reference line intra prediction (TMRL) mode, and deriving one or more angular intra modes for a coding block further comprises:
sorting a plurality of combinations in a TMRL candidate list in an ascending order based on a sum of absolute difference (SAD) cost, one combination comprising a reference line candidate and an angular intra mode; and
selecting one or more combinations with the least SAD cost from the TMRL candidate list.

73. The method according to clause 68, wherein the encoding further comprises:
determining a final intra filter to be the selected one or more intra filter or using mode dependent intra reference sample smoothing (MDIS) condition.

74. The method according to clause 73, wherein determining the final intra filter to be the selected one or more intra filter or using the MDIS condition further comprises:
in response to the TM cost for all combinations is equal, determining the final intra filter using the MDIS condition.

75. The method according to clause 73, wherein determining the final intra filter to be the selected one or more intra filter or using the MDIS condition is based on a threshold, and determining the final intra filter to be the selected one or more intra filter or using the MDIS condition further comprises:
obtaining a TM cost for intra filter selected using the MDIS condition;
in response to a ratio of the TM cost of the selected one or more intra filters to the TM cost for intra filter selected using the MDIS condition being greater than the threshold, determining the final intra filter using the MDIS condition, wherein the threshold is equal to or smaller than 1.

76. The method according to clause 73, wherein determining the final intra filter to be the selected one or more intra filters or using the MDIS condition is based on an area of the coding block, wherein determining the final intra filter to be the selected one or more intra filters or using the MDIS condition comprises:
in response to an area of the coding block being in a range, determining the final intra filter to be the selected one or more intra filters.

77. The method according to clause 73, wherein determining the final intra filter to be the selected one or more intra filters or using the MDIS condition is based on a template shape of the coding block, and determining the final intra filter to be the selected one or more intra filter or using the MDIS condition further comprises:
determining the template shape of the coding block;
in response to the template shape comprising a left template and an above template, determining the final intra filter to be the selected one or more intra filters.

78. A method for signaling a bitstream, the method comprising:
receiving a video sequence;
   encoding the video sequence by:
determining a coding mode for a coding block and a block size of the coding block, wherein the coding mode comprises a template-based intra mode derivation (TIMD) mode or a decoder-side intra mode derivation (DIMD) mode;
determining a distance between an intra mode of the coding block and a horizontal prediction mode or a vertical prediction mode;
selecting an intra filter based on the coding mode, the block size, and the distance; and
performing intra prediction on the coding block using the selected intra filter; and
signaling a bitstream that is generated based on the encoding.

79. The method according to clause 78, wherein selecting an intra filter based on the coding mode, the block size, and the distance further comprises:
determining a threshold corresponding to the coding mode and the block size;
comparing the distance and the threshold;
in response to the distance being greater than the threshold, determining a smoothing interpolation filter (SIF) to be the intra filter;
in response to the distance being equal to or smaller than the threshold, determining a discrete cosine transform-based interpolation filter (DCTIF) to be the intra filter.

80. A method for signaling a bitstream, the method comprising:
receiving a video sequence;
   encoding the video sequence by:
selecting an intra filter for a template region of a coding block based on MDIS condition; and
performing intra prediction on the template region using the selected intra filter; and
signaling a bitstream that is generated based on the encoding.

81. The method according to clause 80, wherein the selected intra filter is a first intra filter, and the encoding further comprises:

selecting a second intra filter for the coding block based on the MDIS condition; wherein a filter length and a filter tap coefficients of the first intra filter and the second intra filter are the same.

82. The method according to clause 80, wherein the selected intra filter is a first intra filter, and the encoding further comprises:
selecting a second intra filter for the coding block based on MDIS condition; wherein at least one of a filter length and a filter tap coefficients of the first intra filter and the second intra filter are different.

83. A method for signaling a bitstream, the method comprising:
receiving a video sequence;
   encoding the video sequence by:
determining one or more angular intra modes for intra prediction;
selecting one or more intra filters for the one or more angular intra modes based on rate-distortion optimization (RDO); and
encoding one or more indices indicating the selected intra filters; and
signaling a bitstream that is generated based on the encoding.

84. The method according to clause 83, wherein selecting one or more intra filters for the one or more angular intra modes based on RDO further comprises:
performing one or more RDO tests using different intra filter combinations on the one or more angular intra modes; and
selecting one or more intra filters in an optimal combination, wherein the optimal combination comprises one or more intra filters, and an RDO of the one or more intra filters in the optimal combination is the smallest among all the combinations.

85. The method according to clause 83, wherein determining one or more intra modes for intra prediction further comprises:
determining the one or more angular intra modes using a template matching (TM) method in a template-based intra mode derivation (TIMD) mode.

86. The method according to clause 83, wherein determining one or more angular intra modes for intra prediction further comprises:
determining one or more angular intra modes for the intra prediction based on fusing weights.

87. The method according to clause 83, the encoding further comprises:
determining whether the one or more angular intra modes are fused;
in response to the one or more angular intra modes are fused, selectively bypassing the selecting one or more intra filters for the one or more angular intra modes based on rate-distortion optimization (RDO); and
encoding one or more indices indicating the selected intra filters into a bitstream further comprises:
encoding an index indicating an intra filter for the fused one or more angular intra modes.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method of encoding a video sequence, the method comprising:
receiving a video sequence;
encoding the video sequence by:
deriving one or more intra modes for intra prediction;
performing template matching (TM) tests on a template region using different filters for the one or more intra modes; and
selecting one or more intra filters based on a TM cost.

2. The method according to claim 1, wherein performing the tests using different filters further comprises:
performing the tests on the template region using different filter combinations, wherein a filter combination comprises one or more intra filters; and
selecting one or more intra filters based on the TM cost further comprises:
selecting one or more intra filters in an optimal combination, wherein the optimal combination comprises one or more intra filters, and a TM cost of the one or more intra filters in the optimal combination is the smallest among all the combinations.

3. The method according to claim 1, wherein selecting the one or more intra filters based on the TM cost is performed for candidate list construction for a coding block.

4. The method according to claim 3, wherein deriving one or more angular intra modes further comprises:
constructing a candidate list comprising a plurality of candidates; and
obtaining a plurality of combinations by combining each of the plurality of candidates with different intra filters; and
performing the TM tests on the template region using different intra filters further comprises:
performing the TM tests using the plurality of combinations; and
selecting one or more intra filters based on the TM cost further comprises:
selecting one or more combinations from the plurality of combinations based on the TM cost.

5. The method according to claim 3, wherein deriving one or more angular intra modes further comprises:
constructing a candidate list comprising a plurality of candidates;
performing the TM tests on the template region using different intra filters further comprises:
performing the TM tests using different intra filters for each candidate; and
selecting one or more intra filters based on the TM cost further comprises:
selecting an intra filter for the each candidate based on the TM cost;
obtaining a plurality of combinations of the intra filter and a corresponding candidate; and
selecting one or more combinations from the plurality of combinations.

6. The method according to claim 3, wherein deriving one or more angular intra modes further comprises:
constructing a candidate list comprising a plurality of candidates; and
selecting one or more candidates from the plurality of candidates; and
performing the TM tests on the template region using different intra filters further comprises:
performing the TM tests using different intra filters for each of the selected one or more candidates.

7. The method according to claim 3, wherein deriving one or more angular intra modes further comprises:
constructing a candidate list comprising a plurality of candidates;
selecting one or more candidates from the plurality of candidates; and
obtaining a rate-distortion optimization (RDO) list by sorting the selected one or more candidates and other intra mode based on sum of absolute transformed difference (SATD); and
performing the TM tests on the template region using different intra filters further comprises:
performing the TM tests using different intra filters for each candidate in the RDO list.

8. A method for decoding a bitstream, the method comprising:
receiving a bitstream; and
decoding the bitstream to output a video sequence, the decoding comprising:
deriving one or more intra modes for intra prediction;
performing template matching (TM) tests on a template region using different filters for the one or more intra modes; and
selecting one or more intra filters based on a TM cost.

9. The method according to claim 8, wherein performing the tests using different filters further comprises:
performing the tests on the template region using different filter combinations, wherein a filter combination comprises one or more intra filters; and
selecting one or more intra filters based on the TM cost further comprises:
selecting one or more intra filters in an optimal combination, wherein the optimal combination comprises one or more intra filters, and a TM cost of the one or more intra filters in the optimal combination is the smallest among all the combinations.

10. The method according to claim 8, wherein selecting the one or more intra filters based on the TM cost is performed for candidate list construction for a coding block.

11. The method according to claim 10, wherein deriving one or more angular intra modes further comprises:
constructing a candidate list comprising a plurality of candidates; and
obtaining a plurality of combinations by combining each of the plurality of candidates with different intra filters; and
performing the TM tests on the template region using different intra filters further comprises:
performing the TM tests using the plurality of combinations; and
selecting one or more intra filters based on the TM cost further comprises:
selecting one or more combinations from the plurality of combinations based on the TM cost.

12. The method according to claim 10, wherein deriving one or more angular intra modes further comprises:
constructing a candidate list comprising a plurality of candidates;
performing the TM tests on the template region using different intra filters further comprises:
performing the TM tests using different intra filters for each candidate; and
selecting one or more intra filters based on the TM cost further comprises:
selecting an intra filter for the each candidate based on the TM cost;
obtaining a plurality of combinations of the intra filter and a corresponding candidate; and
selecting one or more combinations from the plurality of combinations.

13. The method according to claim 10, wherein deriving one or more angular intra modes further comprises:
constructing a candidate list comprising a plurality of candidates; and
selecting one or more candidates from the plurality of candidates; and
performing the TM tests on the template region using different intra filters further comprises:
performing the TM tests using different intra filters for each of the selected one or more candidates.

14. The method according to claim 10, wherein deriving one or more angular intra modes further comprises:
constructing a candidate list comprising a plurality of candidates;
selecting one or more candidates from the plurality of candidates; and
obtaining a rate-distortion optimization (RDO) list by sorting the selected one or more candidates and other intra mode based on sum of absolute transformed difference (SATD); and
performing the TM tests on the template region using different intra filters further comprises:
performing the TM tests using different intra filters for each candidate in the RDO list.

15. A method for signaling a bitstream, the method comprising:
receiving a video sequence;
encoding the video sequence by:
deriving one or more intra modes for intra prediction;
performing template matching (TM) tests on a template region using different filters for the one or more intra modes; and
selecting one or more intra filters based on a TM cost; and
signaling a bitstream that is generated based on the encoding.

16. The method according to claim 15, wherein performing the tests using different filters further comprises:
performing the tests on the template region using different filter combinations, wherein a filter combination comprises one or more intra filters; and
selecting one or more intra filters based on the TM cost further comprises:
selecting one or more intra filters in an optimal combination, wherein the optimal combination comprises one or more intra filters, and a TM cost of the one or more intra filters in the optimal combination is the smallest among all the combinations.

17. The method according to claim 15, wherein selecting the one or more intra filters based on the TM cost is performed for candidate list construction for a coding block.

18. The method according to claim 17, wherein deriving one or more angular intra modes further comprises:
constructing a candidate list comprising a plurality of candidates; and
obtaining a plurality of combinations by combining each of the plurality of candidates with different intra filters; and
performing the TM tests on the template region using different intra filters further comprises:
performing the TM tests using the plurality of combinations; and
selecting one or more intra filters based on the TM cost further comprises:
selecting one or more combinations from the plurality of combinations based on the TM cost.

19. The method according to claim 17, wherein deriving one or more angular intra modes further comprises:
constructing a candidate list comprising a plurality of candidates;
performing the TM tests on the template region using different intra filters further comprises:
performing the TM tests using different intra filters for each candidate; and
selecting one or more intra filters based on the TM cost further comprises:
selecting an intra filter for the each candidate based on the TM cost;
obtaining a plurality of combinations of the intra filter and a corresponding candidate; and
selecting one or more combinations from the plurality of combinations.

20. The method according to claim 17, wherein deriving one or more angular intra modes further comprises:
constructing a candidate list comprising a plurality of candidates; and
selecting one or more candidates from the plurality of candidates; and
performing the TM tests on the template region using different intra filters further comprises:
performing the TM tests using different intra filters for each of the selected one or more candidates.
